(19) United States
(12) Patent Application Publication
(10) Pub. No.: US 2025/0386250 A1
(43) Pub. Date: Dec. 18, 2025

(54) TECHNIQUES FOR ROAMING USING CANDIDATE ACCESS POINT MOBILITY SETS

(71) Applicant: QUALCOMM Incorporated, San Diego, CA (US)

(72) Inventors: Giovanni CHISCI, San Diego, CA (US); Sai Yiu Duncan HO, San Diego, CA (US); Abhishek Pramod PATIL, San Diego, CA (US); George CHERIAN, San Diego, CA (US); Alfred ASTERJADHI, San Diego, CA (US); Sherief HELWA, San Diego, CA (US); Sanket Sanjay KALAMKAR, San Diego, CA (US); Gaurang NAIK, San Diego, CA (US)

(21) Appl. No.: 19/236,457

(22) Filed: Jun. 12, 2025

Related U.S. Application Data
(60) Provisional application No. 63/660,964, filed on Jun. 17, 2024.
(60) Provisional application No. 63/690,015, filed on Sep. 3, 2024.

(51) Int. Cl. H04W 36/00; H04W 36/08; H04W 36/30

(52) U.S. Cl. CPC H04W 36/0016; H04W 36/00835; H04W 36/08; H04W 36/302

(57) ABSTRACT

This disclosure provides methods, components, devices and systems for techniques for roaming using candidate access point (AP) mobility sets (CAMSs). Various aspects generally relate to methods for a non-AP device to generate a CAMS (such as a candidate AP multi-link device (MLD) set) for performing roaming. Various aspects relate more specifically to techniques for the STA to transmit a link preparation request message requesting for the AP to generate a CAMS including a set of AP MLDs with one or more resources prepared for the STA to perform roaming. The AP may indicate the CAMS to the STA in response to the link preparation request, and the STA may accordingly transmit a roaming indication (RAI) message indicating an AP MLD of the CAMS to which the STA may perform roaming.

### CROSS REFERENCES

The present Application for Patent claims benefit of U.S. Provisional Patent Application No. 63/660,964 by CHISCI et al., entitled “TECHNIQUES FOR ROAMING USING CANDIDATE ACCESS POINT MOBILITY SETS,” filed Jun. 17, 2024, and U.S. Provisional Patent Application No. 63/690,015 by CHISCI et al., entitled “TECHNIQUES FOR ROAMING USING CANDIDATE ACCESS POINT MOBILITY SETS,” filed Sep. 3, 2024, which are assigned to the assignee hereof, and expressly incorporated herein.

### TECHNICAL FIELD

This disclosure relates generally to wireless communication and, more specifically, to techniques for roaming using candidate access point mobility sets.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless device. The wireless device may include a processing system that includes processor circuitry and memory circuitry that stores code. The processing system may be configured to cause the wireless device to a processing system that includes processor circuitry and memory circuitry that stores code, the processing system configured to cause the wireless device to, transmit a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain, receive a link preparation response indicating a set of the one or more second AP devices that have prepared one or more resources for the roaming, and transmit a roaming request message indicating at least one second AP device of the set of the one or more second AP devices.

Another innovative aspect of the subject matter described in this disclosure can be implemented in a method by a wireless device. The method may include a processing system that includes processor circuitry and memory circuitry that stores code, the processing system configured to cause the wireless device to, transmitting a link preparation request message to a first access point (AP) device, the link preparation request message including a request to prepare one or more second AP devices to enable the wireless device for roaming from a third AP device to at least one of the one or more second AP devices, where the first AP device, the one or more second AP devices, and the third AP device are within a same mobility domain, receiving a link preparation response indicating a set of the one or more second AP devices that have prepared one or more resources for the roaming, and transmitting a roaming request message indicating at least one second AP device of the set of the one or more second AP devices.

Another innovative aspect of the subject matter described in this disclosure can be implemented in a wireless device. The wireless device may include means for a processing system that includes processor circuitry and memory circuitry that stores code, the processing system configured to cause the wireless device to, means for transmitting a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain, means for receiving a link preparation response indicating a set of the one or more second AP devices that have prepared one or more resources for the roaming, and means for transmitting a roaming request message indicating at least one second AP device of the set of the one or more second AP devices.

Another innovative aspect of the subject matter described in this disclosure can be implemented in a non-transitory computer-readable medium storing code. The code may include instructions executable by one or more processors to a processing system that includes processor circuitry and memory circuitry that stores code, the processing system configured to cause the wireless device to, transmit a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain, receive a link preparation response indicating a set of the one or more second AP devices that have prepared one or more resources for the roaming, and transmit a roaming request message indicating at least one second AP device of the set of the one or more second AP devices.

Some examples of the method, wireless devices, and non-transitory computer-readable medium described herein may further include operations, features, means, or instructions for receiving a Reduced Neighbor Report (RNR) information element that indicates the one or more second AP devices.

In some examples of the method, wireless devices, and non-transitory computer-readable medium described herein, the RNR information element indicates that the one or more second AP devices may be within the same mobility domain.

In some examples of the method, wireless devices, and non-transitory computer-readable medium described herein, the RNR information element indicates a multi-link device (MLD) identifier (ID), a link ID, or both associated with the one or more second AP devices.

Some examples of the method, wireless devices, and non-transitory computer-readable medium described herein may further include operations, features, means, or instructions for transmitting a query to the first AP device for information associated with the one or more second AP devices and receive a query response indicating which of the one or more second AP devices the wireless device can roam to.

In some examples of the method, wireless devices, and non-transitory computer-readable medium described herein, the query may be included in a probe request frame, a ML probe request, a basic service set (BSS) transition management (BTM) query frame, or a Neighbor Report Request frame.

In some examples of the method, wireless devices, and non-transitory computer-readable medium described herein, the query response may be included in a probe response frame, ML probe response, BTM Request frame, or a Neighbor Report Response frame.

Some examples of the method, wireless devices, and non-transitory computer-readable medium described herein may further include operations, features, means, or instructions for measuring one or more received signal strength indicators associated with the one or more second AP devices, where the link preparation request message may be transmitted based on the measured one or more received signal strength indicators.

Some examples of the method, wireless devices, and non-transitory computer-readable medium described herein may further include operations, features, means, or instructions for estimating one or more additional received signal strength indicators associated with the one or more second AP devices based on the measured one or more received signal strength indicators.

In some examples of the method, wireless devices, and non-transitory computer-readable medium described herein, measuring the one or more received signal strength indicators may include operations, features, means, or instructions for monitoring for one or more beacon frames or one or more broadcast management frames from the one or more second AP devices.

In some examples of the method, wireless devices, and non-transitory computer-readable medium described herein, measuring the one or more received signal strength indicators may include operations, features, means, or instructions for transmitting one or more probe request frames to the one or more second AP devices and receive one or more probe responses from the one or more second AP devices.

In some examples of the method, wireless devices, and non-transitory computer-readable medium described herein, the link preparation request message includes a BTM query frame.

In some examples of the method, wireless devices, and non-transitory computer-readable medium described herein, the link preparation request message, the link preparation response, or both include a bitmap indicating the one or more second AP devices.

In some examples of the method, wireless devices, and non-transitory computer-readable medium described herein, the link preparation request message indicates the one or more second AP devices.

In some examples of the method, wireless devices, and non-transitory computer-readable medium described herein, the link preparation request message omits identification of the one or more second AP devices.

In some examples of the method, wireless devices, and non-transitory computer-readable medium described herein, the link preparation response includes a BTM request frame.

In some examples of the method, wireless devices, and non-transitory computer-readable medium described herein, the link preparation response includes one or more Neighbor Report elements indicating a preparation status of the one or more second AP devices.

In some examples of the method, wireless devices, and non-transitory computer-readable medium described herein, the preparation status of the one or more second AP devices includes one or more preferences associated with roaming to each AP devices of the set of the one or more second AP devices.

In some examples of the method, wireless devices, and non-transitory computer-readable medium described herein, the one or more preferences associated with roaming to each AP device of the set of the one or more second AP devices may be associated with one or more preference intervals and each preference interval of the one or more preference intervals may be associated with a level of support for roaming to a corresponding AP device.

In some examples of the method, wireless devices, and non-transitory computer-readable medium described herein, the preparation status indicates one or more AP devices that may be unavailable for roaming.

In some examples of the method, wireless devices, and non-transitory computer-readable medium described herein, the link preparation response indicates that the set of the one or more second AP devices satisfy one or more quality of service thresholds associated with the wireless device, where in the link preparation response indicates an additional set of the one or more second AP devices that do not satisfy the one or more quality of service thresholds.

In some examples of the method, wireless devices, and non-transitory computer-readable medium described herein, the link preparation response indicates a degree of availability of the set of the one or more second AP devices.

In some examples of the method, wireless devices, and non-transitory computer-readable medium described herein, the link preparation response indicates one or more stream classification service (SCS) IDs of one or more data flows associated with the wireless device that a respective one of the set of the one or more second AP devices may be capable of satisfying.

In some examples of the method, wireless devices, and non-transitory computer-readable medium described herein, transmitting the roaming request message may include operations, features, means, or instructions for transmitting the roaming request message during a roaming interval, where the roaming interval starts a first threshold time after transmitting the link preparation request message or after receiving the link preparation response and ends a second threshold time after transmitting the link preparation request message or after receiving the link preparation response.

In some examples of the method, wireless devices, and non-transitory computer-readable medium described herein, the link preparation response includes an indication of a duration of the roaming interval and the duration corresponds to a time during which the set of the one or more second AP devices will hold the prepared one or more resources.

In some examples of the method, wireless devices, and non-transitory computer-readable medium described herein, the first AP device may be a same AP device as the third AP device.

In some examples of the method, wireless devices, and non-transitory computer-readable medium described herein, the first AP device may be one of the one or more second AP devices.

In some examples of the method, wireless devices, and non-transitory computer-readable medium described herein, the first AP device may be the at least one second AP device of the set of the one or more second AP devices.

In some examples of the method, wireless devices, and non-transitory computer-readable medium described herein, the roaming request message may be a Link Reconfiguration Request frame.

Some examples of the method, wireless devices, and non-transitory computer-readable medium described herein may further include operations, features, means, or instructions for receiving a roaming response from the third AP device or from the at least one second AP device of the set of the one or more second AP devices.

Some examples of the method, wireless devices, and non-transitory computer-readable medium described herein may further include operations, features, means, or instructions for performing a link remove operation to remove one or more links associated with the third AP device in response to the roaming response.

In some examples of the method, wireless devices, and non-transitory computer-readable medium described herein, performing the link remove operation may include operations, features, means, or instructions for transmitting a Link Reconfiguration Request frame to the at least one second AP device of the one or more second AP devices, where the Link Reconfiguration Request frame indicates the third AP device.

In some examples of the method, wireless devices, and non-transitory computer-readable medium described herein, the Link Reconfiguration Request frame indicates one or more links associated with the third AP device that may be requested for removal.

In some examples of the method, wireless devices, and non-transitory computer-readable medium described herein, the roaming response may be a Link Reconfiguration Response frame indicating acceptance or rejection of the at least one second AP device of the set of the one or more second AP devices.

In some examples of the method, wireless devices, and non-transitory computer-readable medium described herein, the roaming response may be a Link Reconfiguration Response frame.

In some examples of the method, wireless devices, and non-transitory computer-readable medium described herein, the link preparation request message identifies the one or more second AP devices.

In some examples of the method, wireless devices, and non-transitory computer-readable medium described herein, the link preparation request message indicates one or more links of the at least one second AP device of the one or more second AP devices that may be requested.

In some examples of the method, wireless devices, and non-transitory computer-readable medium described herein, the link preparation request message identifies the at least one second AP device of the one or more second AP devices.

In some examples of the method, wireless devices, and non-transitory computer-readable medium described herein, a size of the set of the one or more second AP devices may be defined according to a rule.

In some examples of the method, wireless devices, and non-transitory computer-readable medium described herein, transmitting the roaming request message may include operations, features, means, or instructions for transmitting the roaming request message to the third AP device.

In some examples of the method, wireless devices, and non-transitory computer-readable medium described herein, transmitting the roaming request message may include operations, features, means, or instructions for transmitting the roaming request message to the at least one second AP device of the one or more second AP devices.

In some examples of the method, wireless devices, and non-transitory computer-readable medium described herein, the link preparation request message may be a Link Reconfiguration Request frame that requests for the first AP device to prepare the one or more second AP devices for roaming.

In some examples of the method, wireless devices, and non-transitory computer-readable medium described herein, the link preparation response may be a Link Reconfiguration Response frame that includes a status of link preparation for each of the one or more second AP devices in response to the Link Reconfiguration Request frame.

In some examples of the method, wireless devices, and non-transitory computer-readable medium described herein, the roaming request message may be a Link Reconfiguration Request frame that requests to add one or more links of the at least one second AP device of the set of the one or more second AP devices.

In some examples of the method, wireless devices, and non-transitory computer-readable medium described herein, the first AP device, the third AP device, the one or more second AP devices, or any combination thereof may be an AP MLD or an AP station (STA).

In some examples of the method, wireless devices, and non-transitory computer-readable medium described herein, the wireless device may be a non-AP MLD or a non-AP STA.

Another innovative aspect of the subject matter described in this disclosure can be implemented in a method by a wireless device. The method may include a processing system that includes processor circuitry and memory circuitry that stores code, the processing system configured to cause the wireless device to, transmitting a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain, receiving a link preparation response indicating a set of the one or more second AP devices, and transmitting a roaming request message indicating at least one second AP device of the set of the one or more second AP devices.

Another innovative aspect of the subject matter described in this disclosure can be implemented in a wireless device. The wireless device may include a processing system that includes processor circuitry and memory circuitry that stores code. The processing system may be configured to cause the wireless device to a processing system that includes processor circuitry and memory circuitry that stores code, the processing system configured to cause the wireless device to, transmit a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain, receive a link preparation response indicating a set of the one or more second AP devices, and transmit a roaming request message indicating at least one second AP device of the set of the one or more second AP devices.

Another innovative aspect of the subject matter described in this disclosure can be implemented in a wireless device. The wireless device may include means for a processing system that includes processor circuitry and memory circuitry that stores code, the processing system configured to cause the wireless device to, means for transmitting a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain, means for receiving a link preparation response indicating a set of the one or more second AP devices, and means for transmitting a roaming request message indicating at least one second AP device of the set of the one or more second AP devices.

Another innovative aspect of the subject matter described in this disclosure can be implemented in a non-transitory computer-readable medium storing code. The code may include instructions executable by one or more processors to a processing system that includes processor circuitry and memory circuitry that stores code, the processing system configured to cause the wireless device to, transmit a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain, receive a link preparation response indicating a set of the one or more second AP devices, and transmit a roaming request message indicating at least one second AP device of the set of the one or more second AP devices.

Some examples of the method, wireless devices, and non-transitory computer-readable medium described herein may further include operations, features, means, or instructions for receiving a RNR information element that indicates the one or more second AP devices.

In some examples of the method, wireless devices, and non-transitory computer-readable medium described herein, the RNR information element indicates that the one or more second AP devices may be within the same mobility domain.

In some examples of the method, wireless devices, and non-transitory computer-readable medium described herein, the RNR information element indicates a MLD ID, a link ID, or both associated with the one or more second AP devices.

Some examples of the method, wireless devices, and non-transitory computer-readable medium described herein may further include operations, features, means, or instructions for transmitting a query to the first AP device for information associated with the one or more second AP devices and receive a query response indicating which of the one or more second AP devices the wireless device can roam to.

In some examples of the method, wireless devices, and non-transitory computer-readable medium described herein, the query may be included in a probe request frame, a ML probe request, a BTM query frame, or a Neighbor Report Request frame.

In some examples of the method, wireless devices, and non-transitory computer-readable medium described herein, the query response may be included in a probe response frame, ML probe response, BTM Request frame, or a Neighbor Report Response frame.

In some examples of the method, wireless devices, and non-transitory computer-readable medium described herein, the link preparation request message includes a BTM query frame.

In some examples of the method, wireless devices, and non-transitory computer-readable medium described herein, the link preparation request message indicates the one or more second AP devices.

In some examples of the method, wireless devices, and non-transitory computer-readable medium described herein, the link preparation request message omits identification of the one or more second AP devices.

In some examples of the method, wireless devices, and non-transitory computer-readable medium described herein, the link preparation response includes a BTM request frame.

In some examples of the method, wireless devices, and non-transitory computer-readable medium described herein, the link preparation response includes one or more Neighbor Report elements indicating a preparation status of the one or more second AP devices.

In some examples of the method, wireless devices, and non-transitory computer-readable medium described herein, the preparation status of the one or more second AP devices includes one or more preferences associated with roaming to each AP devices of the set of the one or more second AP devices.

In some examples of the method, wireless devices, and non-transitory computer-readable medium described herein, the one or more preferences associated with roaming to each AP device of the set of the one or more second AP devices may be associated with one or more preference intervals and each preference interval of the one or more preference intervals may be associated with a level of support for roaming to a corresponding AP device.

In some examples of the method, wireless devices, and non-transitory computer-readable medium described herein, the preparation status indicates one or more AP devices that may be unavailable for roaming.

In some examples of the method, wireless devices, and non-transitory computer-readable medium described herein, the link preparation response indicates that the set of the one or more second AP devices satisfy one or more quality of service thresholds associated with the wireless device, where in the link preparation response indicates an additional set of the one or more second AP devices that do not satisfy the one or more quality of service thresholds.

In some examples of the method, wireless devices, and non-transitory computer-readable medium described herein, the link preparation response indicates a degree of availability of the set of the one or more second AP devices.

In some examples of the method, wireless devices, and non-transitory computer-readable medium described herein, the link preparation response indicates one or more SCS IDs of one or more data flows associated with the wireless device that a respective one of the set of the one or more second AP devices may be capable of satisfying.

In some examples of the method, wireless devices, and non-transitory computer-readable medium described herein, transmitting the roaming request message may include operations, features, means, or instructions for transmitting the roaming request message during a roaming interval, where the roaming interval starts a first threshold time after transmitting the link preparation request message or after receiving the link preparation response and ends a second threshold time after transmitting the link preparation request message or after receiving the link preparation response.

In some examples of the method, wireless devices, and non-transitory computer-readable medium described herein, the link preparation response includes an indication of a duration of the roaming interval and the duration corresponds to a time during which the set of the one or more second AP devices will hold one or more prepared resources.

In some examples of the method, wireless devices, and non-transitory computer-readable medium described herein, the first AP device may be a same AP device as the third AP device.

In some examples of the method, wireless devices, and non-transitory computer-readable medium described herein, the first AP device may be one of the one or more second AP devices.

In some examples of the method, wireless devices, and non-transitory computer-readable medium described herein, the first AP device may be the at least one second AP device of the set of the one or more second AP devices.

In some examples of the method, wireless devices, and non-transitory computer-readable medium described herein, the roaming request message may be a Link Reconfiguration Request frame.

Some examples of the method, wireless devices, and non-transitory computer-readable medium described herein may further include operations, features, means, or instructions for transmitting the roaming request message to one of the third AP device or to the at least one second AP device of the set of the one or more second AP devices and receive a roaming response from the one of the third AP device or from the at least one second AP device of the set of the one or more second AP devices.

Some examples of the method, wireless devices, and non-transitory computer-readable medium described herein may further include operations, features, means, or instructions for performing a link remove operation to remove one or more links associated with the third AP device in response to the roaming response.

In some examples of the method, wireless devices, and non-transitory computer-readable medium described herein, performing the link remove operation may include operations, features, means, or instructions for transmitting a Link Reconfiguration Request frame to the at least one second AP device of the one or more second AP devices, where the Link Reconfiguration Request frame indicates the third AP device.

In some examples of the method, wireless devices, and non-transitory computer-readable medium described herein, the Link Reconfiguration Request frame indicates one or more links associated with the third AP device that may be requested for removal.

In some examples of the method, wireless devices, and non-transitory computer-readable medium described herein, the roaming response may be a Link Reconfiguration Response frame.

In some examples of the method, wireless devices, and non-transitory computer-readable medium described herein, the link preparation request message identifies the at least one second AP device of the one or more second AP devices.

In some examples of the method, wireless devices, and non-transitory computer-readable medium described herein, the link preparation request message indicates one or more links of the at least one second AP device of the one or more second AP devices that may be requested.

In some examples of the method, wireless devices, and non-transitory computer-readable medium described herein, the first AP device, the third AP device, the one or more second AP devices, or any combination thereof may be an AP MLD or an AP STA.

In some examples of the method, wireless devices, and non-transitory computer-readable medium described herein, the wireless device may be a non-AP MLD or a non-AP STA.

Another innovative aspect of the subject matter described in this disclosure can be implemented in a first AP device for wireless communications. The first AP device may include a processing system that includes processor circuitry and memory circuitry that stores code. The processing system may be configured to cause the first AP device to receive a link preparation request message from a wireless device, the link preparation request message including a request to prepare one or more second AP devices to enable the wireless device for roaming from a third AP device to at least one of the one or more second AP devices, where the one or more second AP devices are within a same mobility domain as the first AP device and the third AP device and transmit a link preparation response indicating a set of the one or more second AP devices that have prepared one or more resources for the roaming.

Another innovative aspect of the subject matter described in this disclosure can be implemented in a method for wireless communications by a first AP device. The method may include receiving a link preparation request message from a wireless device, the link preparation request message including a request to prepare one or more second AP devices to enable the wireless device for roaming from a third AP device to at least one of the one or more second AP devices, where the one or more second AP devices are within a same mobility domain as the first AP device and the third AP device and transmitting a link preparation response indicating a set of the one or more second AP devices that have prepared one or more resources for the roaming.

Another innovative aspect of the subject matter described in this disclosure can be implemented in a first AP device for wireless communications. The first AP device may include means for receiving a link preparation request message from a wireless device, the link preparation request message including a request to prepare one or more second AP devices to enable the wireless device for roaming from a third AP device to at least one of the one or more second AP devices, where the one or more second AP devices are within a same mobility domain as the first AP device and the third AP device and means for transmitting a link preparation response indicating a set of the one or more second AP devices that have prepared one or more resources for the roaming.

Another innovative aspect of the subject matter described in this disclosure can be implemented in a non-transitory computer-readable medium storing code for wireless communications. The code may include instructions executable by one or more processors to receive a link preparation request message from a wireless device, the link preparation request message including a request to prepare one or more second AP devices to enable the wireless device for roaming from a third AP device to at least one of the one or more second AP devices, where the one or more second AP devices are within a same mobility domain as the first AP device and the third AP device and transmit a link preparation response indicating a set of the one or more second AP devices that have prepared one or more resources for the roaming.

In some examples of the method, first APs, and non-transitory computer-readable medium described herein, the first AP device may be one of the one or more second AP devices.

Some examples of the method, first APs, and non-transitory computer-readable medium described herein may further include operations, features, means, or instructions for transmitting, to the third AP device, a context transfer request for the third AP device to transfer context information of the wireless device from the third AP device to the set of the one or more second AP devices based on the link preparation request message.

In some examples of the method, first APs, and non-transitory computer-readable medium described herein, the first AP device may be a same AP device as the third AP device.

Some examples of the method, first APs, and non-transitory computer-readable medium described herein may further include operations, features, means, or instructions for performing a context transfer to transfer context information of the wireless device from the third AP device to the set of the one or more second AP devices based on the link preparation request message, where the link preparation response indicates that the third AP device may have initiated transfer or completed transfer of at least a first portion of the context information of the wireless device to the set of the one or more second AP devices or that the set of the one or more second AP devices may have initiated storage or completed storage of at least the first portion of the context information of the wireless device.

Some examples of the method, first APs, and non-transitory computer-readable medium described herein may further include operations, features, means, or instructions for receiving a query from the wireless device for information associated with the one or more second AP devices and transmitting a query response indicating which of the one or more second AP devices the wireless device can roam to.

In some examples of the method, first APs, and non-transitory computer-readable medium described herein, the query may be included in a probe request frame, a multi-link probe request, a BTM query frame, or a Neighbor Report Request frame.

In some examples of the method, first APs, and non-transitory computer-readable medium described herein, the query response may be included in a probe response frame, a multi-link probe response, a BTM Request frame, or a Neighbor Report Response frame.

Some examples of the method, first APs, and non-transitory computer-readable medium described herein may further include operations, features, means, or instructions for receiving a roaming request message indicating at least one second AP device of the set of the one or more second AP devices for which the wireless device requests to perform the roaming.

In some examples of the method, first APs, and non-transitory computer-readable medium described herein, the first AP device may be the at least one second AP device of the set of the one or more second AP devices.

Some examples of the method, first APs, and non-transitory computer-readable medium described herein may further include operations, features, means, or instructions for performing a distribution system (DS) path switching procedure to transfer the wireless device from the third AP device to the at least one second AP device of the set of the one or more second AP devices in response to the roaming request message.

Some examples of the method, first APs, and non-transitory computer-readable medium described herein may further include operations, features, means, or instructions for performing a context transfer to transfer context information of the wireless device from the third AP device to the at least one second AP device of the set of the one or more second AP devices for which the wireless device requests to perform the roaming based on the roaming request message.

Some examples of the method, first APs, and non-transitory computer-readable medium described herein may further include operations, features, means, or instructions for transmitting, to the third AP device, a context transfer request for the third AP device to transfer context information of the wireless device from the third AP device to the at least one second AP device of the set of the one or more second AP devices based on the roaming request message.

In some examples of the method, first APs, and non-transitory computer-readable medium described herein, receiving the roaming request message may include operations, features, means, or instructions for receiving the roaming request message during a roaming duration, where the roaming duration starts a first threshold time after the link preparation request message may be received or after the link preparation response may be transmitted and ends a second threshold time after the link preparation request message may be received or after the link preparation response may be transmitted.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example PPDU usable for communications between a wireless AP and one or more wireless STAs.

FIG. 3 shows an example of a signaling diagram that supports techniques for roaming using candidate access point mobility sets.

FIG. 4 shows an example of a process flow that supports techniques for roaming using candidate access point mobility sets.

FIG. 5 shows a block diagram of an example wireless communication device that supports techniques for roaming using candidate access point mobility sets.

FIG. 6 shows a block diagram of an example wireless communication device that supports techniques for roaming using candidate access point mobility sets.

FIGS. 7, 8, and 9 show flowcharts illustrating example processes performable by or at a first wireless device in a wireless network that support techniques for roaming using candidate access point mobility sets.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a non-access point (AP) device (such as a non-AP station (STA) or a non-AP multi-link device (MLD) with one or more affiliated non-AP STAs) may be mobile and may therefore perform a roaming procedure in which the non-AP device may switch from communicating with a first AP to communicating with a second AP (such as an AP MLD with one or more affiliated APs or an AP STA). In such examples, the non-AP device may perform re-association and re-authentication to switch from the first AP to the second AP, which may increase latency in the wireless communication system.

Various aspects generally relate to methods for the non-AP device to obtain a candidate AP mobility set (CAMS) (such as a candidate AP MLD set) for performing seamless roaming. As described herein, roaming may refer to a distribution system (DS) mapping a change of the non-AP device from a former serving AP to a target AP. Various aspects relate more specifically to techniques for the non-AP device to transmit a preparation request message (such as a link preparation request message) requesting for an AP of a mobility domain (a serving AP, another AP) to generate a CAMS including a set of AP MLDs of the mobility domain with one or more resources prepared for the non-AP device to perform roaming. As described herein, preparing resources may refer to AP MLDs of the mobility domain exchanging messages over the DS or over the air such that the one or more AP MLDs (upon verifying that the non-AP device may be served) allocate resources, prepare data structures, store parameters (such as context information of the non-AP device), and so on. For example, the candidate APs may be provisioned with static context of the client (such as security keys, blockAck context, and so on) and by each of the candidate APs may reserve the necessary resources to support quality of service (QOS) parameters (such as requirements) of the non-AP device. The non-AP device may receive uninterrupted service while roaming from a serving AP to a target AP as a result of the prepared resources.

The AP may indicate the CAMS to the non-AP device in response to the link preparation request. The non-AP device may accordingly transmit a roaming request indication (RRI) message to the AP or to another AP of the mobility domain indicating an AP MLD of the CAMS to which the non-AP device may perform roaming. The RRI message, the link preparation request message, or both may be a version of a Link Reconfiguration Request frame (such as indicating link ADD) or it another frame. The frame could include a Reconfiguration Multi-Link IE (R-ML IE) that indicates the links of the target AP MLD to include as part of the roaming. The frame may include one or more other elements and fields.

Upon receiving an RAI message, the AP that received the RAI message may transmit a roaming request response (RRR) response to the non-AP device (via its affiliated AP). The RRR message, the link preparation response message, or both may be a version of a Link Reconfiguration Response frame indicating the links that are accepted or another frame. The frame may include a Basic Multi-Link element indicating one or more links of the target AP MLD that are accepted as part of the roaming. The frame may include one or more other elements and fields. The AP may transmit an RRR to the non-AP device upon completion of one or more roaming procedures (such as to mark completion of roaming the non-AP device from a previous serving AP to a target AP).

Particular aspects of the subject matter described in this disclosure may be implemented to realize one or more of the following potential advantages. The techniques employed by the described communication devices may provide benefits and enhancements to the operation of the communication devices, including increased efficiency associated with roaming. For example, operations performed by the described communication devices may provide improvements to roaming techniques by enabling a non-AP device to identify a set of candidate APs with resources prepared for the roaming, which may reduce latency as a result of providing uninterrupted service.

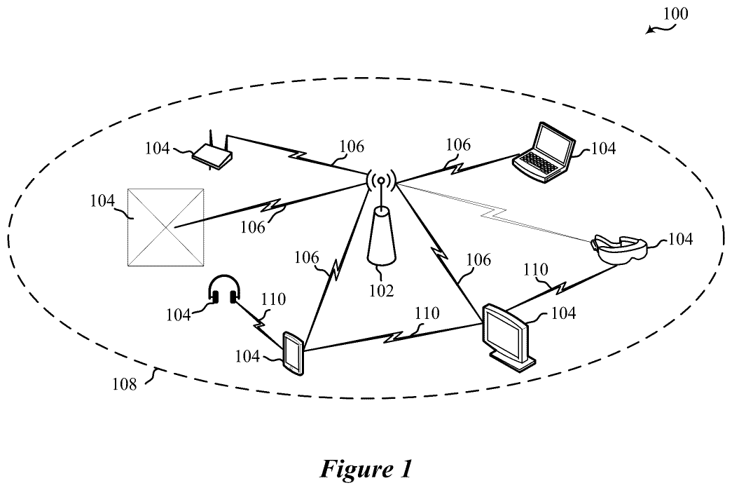

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHZ), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

Techniques described herein may enable a non-AP device to obtain a CAMS (such as a candidate AP MLD set) for performing seamless roaming. The non-AP device may transmit a link preparation request message requesting for an AP 102 of a mobility domain to generate a CAMS including a set of AP MLDs of the mobility domain with one or more resources prepared for the non-AP device to perform roaming. The AP 102 may indicate the CAMS to the non-AP device in response to the link preparation request, and the non-AP device may accordingly transmit a RRI message (to the AP 102 or to another AP 102 of the mobility domain) indicating an AP MLD of the CAMS to which the non-AP device requests to roam to. Upon receiving an RRI message, the AP 102 may transmit an RRR to the non-AP device upon completion of one or more roaming procedures (such as to mark completion of roaming the non-AP device from a previous serving AP 102 to a target AP 102).

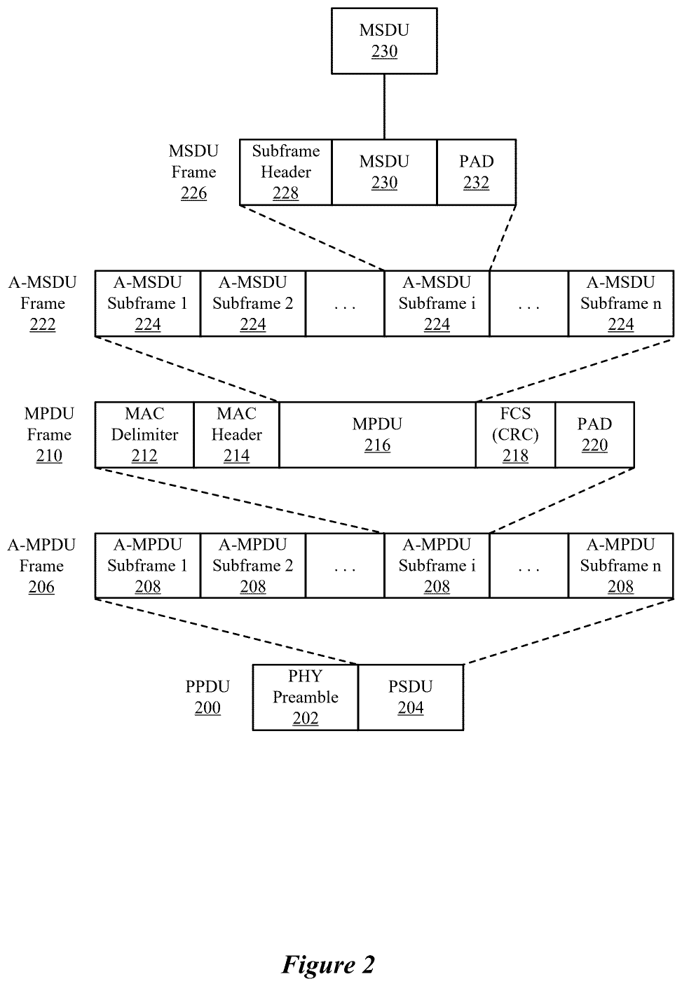

FIG. 2 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 208 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (such as the FCS field 218 may include a cyclic redundancy check (CRC)) and padding bits 220. The MPDU 216 may carry one or more MAC service data units (MSDUs) 230. For example, the MPDU 216 may carry an aggregated MSDU (A-MSDU) 222 including multiple A-MSDU subframes 224. Each A-MSDU subframe 224 may be associated with an MSDU frame 226 and may contain a corresponding MSDU 230 preceded by a subframe header 228 and, in some examples, followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body. The MAC header 214 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 214 also includes one or more fields indicating addresses for the data encapsulated within the frame body. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number Nss of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a seamless mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

Techniques described herein may enable a non-AP device to obtain a CAMS (such as a candidate AP MLD set) for performing seamless roaming. The non-AP device may transmit a link preparation request message requesting for an AP 102 of a mobility domain to generate a CAMS including a set of AP MLDs of the mobility domain with one or more resources prepared for the non-AP device to perform roaming. The AP 102 may indicate the CAMS to the non-AP device in response to the link preparation request, and the non-AP device may accordingly transmit a RRI (to the AP 102 or to another AP 102 of the mobility domain) indicating an AP MLD of the CAMS to which the non-AP device requests to roam to. Upon receiving an RRI message, the AP 102 may transmit an RRR to the non-AP device upon completion of one or more roaming procedures (such as to mark completion of roaming the non-AP device from a previous serving AP 102 to a target AP 102).

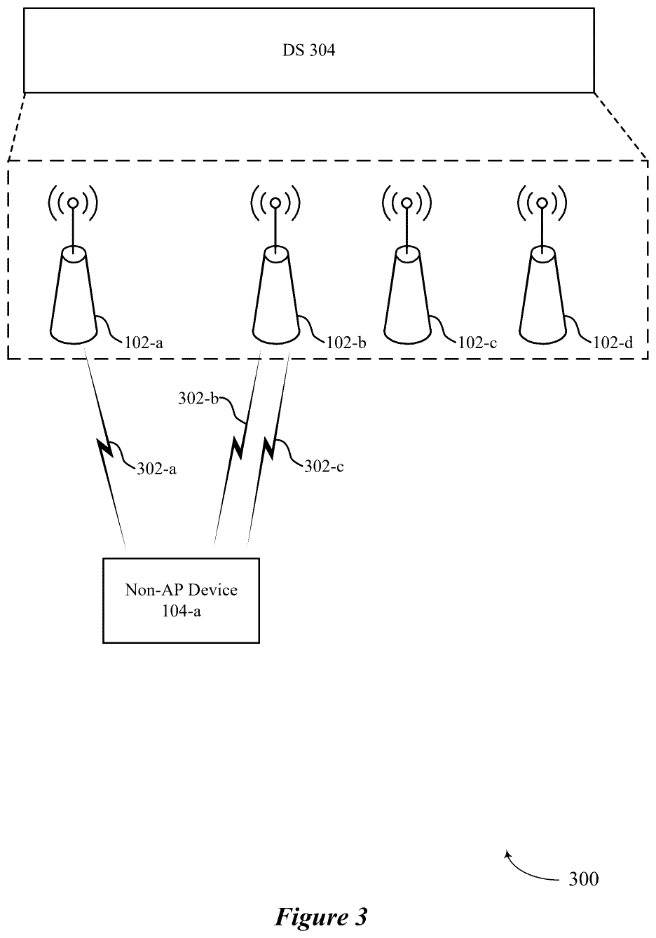

FIG. 3 shows an example of a signaling diagram 300 that supports techniques for roaming using candidate access point mobility sets. The signaling diagram 300 may implement or may be implemented by aspects of the wireless communication network 100 or the PPDU 200. For example, the signaling diagram 300 may implement or may be implemented by a non-AP device 104-a (such as a wireless device, a non-AP STA 104, a non-AP MLD) and one or more APs 102 (such as AP STAs, an AP MLDs), which may be examples of the corresponding devices as described with reference to FIG. 1. In some examples, the signaling diagram 300 may include a DS 304, which may include an AP 102-a, an AP 102-b, an AP 102-c, and an AP 102-d.

As described herein, seamless roaming techniques may enable relatively faster roaming of a non-AP device 104-a (such as a non-AP MLD or a non-AP STA 104) between APs 102 (such as AP MLDs including one or more affiliated APs or AP STAs of a SMD), and may reduce time associated with re-association and re-authentication for roaming. APs 102 of the SMD (such as an AP 102-a, which may be a serving AP 102, an AP 102-b, which may be a target AP 102, an AP 102-c, and an AP 102-d) may operate cooperatively by transmitting signaling over the air or over a DS 304. In some examples, the signaling diagram 300 may include a higher level logical entity (such as the SMD) spanning multiple non-collocated AP MLDs. Accordingly, the non-AP device 104-a may associate with and maintain association and authentication context with the AP MLDs of the SMD.

Techniques described herein may enable the non-AP device to participate in a sequence for the roaming procedure based on obtaining a CAMS. For example, the non-AP device 104-a may obtain the CAMS at a point that is close to a roaming point where the APs 102 may commit one or more resources and gather information about the non-AP device 104-a (such as via the DS 304). The APs 102 may accordingly prepare the CAMS for the transition (such as by allocating resources on a serving or queried AP 102 and/or transferring context information of the non-AP device 104-a), and the non-AP device 104-a may roam from a serving AP 102-a to a target AP 102-b of the CAMS, which may result in relatively more seamless roaming (such as by providing uninterrupted service). In some implementations, the devices of the signaling diagram 300 may perform one or more operations described herein in a given order, or may skip performing one or more operations described herein.

In some examples, the sequence for the roaming procedure may include multiple phases to facilitate transition from a serving AP 102-a (such as an AP MLD) to a target AP 102-b that is in a same SMD as the serving AP 102. For example, the sequence for the roaming procedure may include a discovery phase, a link preparation phase, and a roaming phase. The discover phase may be a phase during which the non-AP device 104-a (such as a client) may discover a neighboring AP (such as one or more neighboring APs 102 that are part of the same SMD as the serving AP 102-a). The link preparation phase may be a phase during which the serving AP 102-a and the non-AP device 104-a may exchange information to facilitate preparation of one or more candidate APs 102 to receive the non-AP device 104-a (such as to enable a relatively fast and smooth transition of the non-AP device 104-a from the serving AP 102-a to the target AP 102-b). The roaming phase may be a phase in which the non-AP device 104-a may roam to the target AP 102-b (such as an AP 102 of the one or more candidate APs 102 that have been prepared to receive the non-AP device 104-a).

In some examples, as part of building the CAMS, the non-AP device 104-a may perform an informative query for readiness of resources on the APs 102 of the SMD. In some examples, the informative query may include receiving neighbor report information for one or more AP devices 102 (such as a Reduced Neighbor Report (RNR) or a neighbor report information element). For example, the non-AP device 104-a may monitor for and receive one or more RNR information element (IE) from the serving AP 102-a. The serving AP 102-a may transmit the RNR IEs via a Beacon or Probe Response frame. Each RNR IE may indicate that a corresponding non-collocated AP 102 is part of the same SMD as the serving AP 102-a. For example, each RNR IE may include a bit field (such as a bitfield B7 in a BSS Parameters subfield of the RNR) that indicates that the corresponding AP 102 is part of the SMD. Additionally, or alternatively, the corresponding RNR IE may include a field (such as a Same SSID field) for which a first value (such as 1) may indicate that the corresponding AP 102 is part of the SMD and a second value (such as 0) may indicate that the corresponding AP 102 is not part of the SMD. Additionally, or alternatively, the corresponding RNR IE may include a value (such as an AP MLD identifier (ID)) that is assigned to the corresponding AP 102. In such examples, the non-AP device 104-a may determine that the corresponding AP 102 is affiliated with the SMD if the value falls within a range (such as if the value is greater than 200), and may determine that the corresponding AP 102 is not affiliated with the SMD if the value is not within the range.

In some examples, the RNR IE may include a subfield (such as an MLD Parameters subfield) that indicates the corresponding AP 102. For example, the subfield may indicate one or more IDs (such as an AP MLD ID and/or a Link ID) associated with the corresponding AP 102. In some examples, a value indicated via the subfield may be based on one or more rules defined according to a technical specification. For example, the non-AP device 104-a may determine that all affiliated APs 102 of an AP MLD associated with a same AP MLD ID may be a neighboring AP MLD in the SMD. In some examples, one or more AP MLDs may be assigned a different AP MLD ID by one or more different AP MLDs. For example, APs 102 in a first AP MLD may assign a first AP MLD ID (such as 25) to a second AP MLD, and APs 102 in a third AP MLD may assign a second AP MLD ID (such as 56) to the second AP MLD.

The RNR IE may include one or more fields with one or more bit octets that may indicate information to the non-AP device 104-a. For example, the RNR IE may include an Element ID field (such as 1 octet), a Length field (such as 1 octet) and one or more Neighbor AP Information Fields of variable length. Each of the Neighbor AP Information Fields may include a TBTT Information Header field (such as 2 octets), an Operating Class field (such as 1 octet), a Channel Number field (such as 1 octet), and a TBTT Information Set of variable length. The TBTT Information Set may include a Neighbor AP TBTT Offset field (such as 1 octet), a BSSID field (such as optionally 0 or 6 octets), a Short SSID field (such as optionally 0 or 4 octets), a BSS parameters field (such as 0 or 1 octet), a 20 MHz PSD field (such as 0 or 1 octets), and an MLD parameters field (such as 0 or 3 octets). The BSS parameters field may include an OCT recommended field (such as 1 bit), a Same SSID field (such as 1 bit), a Multiple BSSID field (such as 1 bit), a Transmitted BSSID field (such as 1 bit), a Member of ESS with 3.4 GHz collocated AP field (such as 1 bit), an Unsolicited Prop Responses Active field (such as 1 bit), a Collocated AP field (such as 1 bit), and a reserved field (such as 1 bit). The MLD Parameters fields may include an AP MLD ID field (such as 8 bits), a Link ID field (such as 4 bits), a BSS Parameters Change Count field (such as 8 bits), an All Updated Included field (such as 1 bit), a Disabled Link Indication field (such as 1 bit), and a Reserved field (such as 1 bit).

In some examples (such as instead of receiving the RNR IE or in response to receiving the RNR IE), the non-AP device 104-a may transmit an informative query to one or more APs 102 in the SMD (such as the serving AP 102-a, another AP 102) to generate a list of potential APs 102 for roaming (such as without the APs 102 performing resource allocation for the roaming non-AP device 104-a). In some examples, the non-AP device 104-a may transmit the informative query in response to the RNR IE to obtain relatively more detailed or complete information about the list of potential APs 102 (such as in comparison to the relatively more rudimentary information included in the RNR IE, such as the AP MLD ID and the affiliation with a same SMD). The non-AP device 104-a may perform a frame exchange with one or more APs 102 of the SMD to gather information on the APs 102 within the SMD that may satisfy traffic parameters associated with the non-AP device 104-a. The non-AP device 104-a may request (such as to the serving AP 102-a or another queried AP 102) which APs 102 in the SMD may accommodate service of the non-AP device 104-a. The non-AP device 104-a may include a set of suggested APs 102 in the request, or the request may omit suggestions.

The serving AP 102-a or queried AP 102 may respond to the request by providing a list of one or more APs 102 that may be ready or able to serve the non-AP device 104-a (such as via a response frame to the non-AP device 104-a). The APs 102 may not commit any resources in response to the informative query. For example, the APs 102 may not add links 102, create data structures, or save or transfer context in response to the informative query. The serving AP 102-a or queried AP 102 may confirm a subset of the APs indicated via the request from the non-AP device 104-a (such as with a bitmap). The serving AP 102-a or the queried AP 102 may add one or more other APs 102 to the list of requested candidate APs 102. The serving AP 102-a or the queried AP 102 may provide a list of recommended APs 102 in the SMD to the non-AP device 104-a. For example, the list may indicate an order of preference for target APs 102 (such as a preference of the network, the DS 304, the SMD, and so on).

In some examples, an AP 102 that supports seamless roaming may provide some information of neighboring APs 102 (such as AP MLDs in the SMD) in one or more beacon and probe response frames of the AP 102. For example, the AP 102 may indicate the information via an extended RNR element (such as by adding a field or using a reserved bit to indicate that a particular reported AP 102 is part of a same SMD as the serving AP 102-a). In some examples, the AP 102 may report one or more other APs 102 that are collocated (such as within a same physical box based on 6 GHz out-of-band discovery and MLO rules to report APs 102 affiliated with the same MLD and rules for reporting APs 102 affiliated with the MLD of a non-transmitted BSSID).

In some examples, an AP 102 that is affiliated with an SMD MLD may provide some information of other APs 102 in its neighborhood that are affiliated with the same SMD MLD. For example, the AP 102 may indicate the information via the RNR element. The AP 102 may report other non-collocated APs 102 (such as APs 102 that are not affiliated with the same SMD as the AP 102). To identify non-collocated APs 102 that belong to the same SMD, the AP 102 may use a field (such as a repurposed reserved bit) in the RNR. For example, a rule in a specification may define for the AP 102 to identify the non-collocated APs 102 in the SMD via the field in the RNR.

Additionally, or alternatively, the AP 102 may use a different signaling mechanism. For example, the non-AP device 104-a may query the serving AP 102-a or another AP 102 by using a multi-link (ML) probe request mechanism. For example, the non-AP device 104-a may transmit an ML probe to the serving AP 102-a requesting relatively more detailed or complete information of a neighboring AP MLD and/or one or more affiliated APs 102 (such as the AP 102-b, the AP 102-c, the AP 102-d). In some examples, the informative query (such as the ML probe) may indicate an AP MLD ID of the requested AP MLD (such as an AP MLD ID indicated in the RNR IE). Additionally, or alternatively, the non-AP device 104-a may transmit the informative query via a BSS transition management (BTM) Query frame, a Neighbor Report Request frame, or another frame to the serving AP 102-a or to another AP 102. Upon receiving a query, the serving AP may respond by transmitting an ML probe response, a BTM Response, a Neighbor Report Response, or another response.

In some examples, the non-AP device 104 may perform an informative scanning for recording received signal strength indicators (RSSIs) of links of the APs 102. The informative scanning may include passive and/or active scanning of APs 102 (within the SMD over the air) performed by the roaming non-AP device 104-a to obtain at least RSSI measurements on one or more operating channels of the APs 102. To perform passive scanning, the non-AP device 104-a may opportunistically detect frames transmitted by the APs 102 and record the RSSIs of the frames. To perform active scanning, the non-AP device 104-a may perform a frame exchange with the APs 102, and record the RSSI of the frames. The non-AP device 104-a may create a list of RSSI of the APs 102. For example, the non-AP device 104-a may record and index the RSSI by one or more of an SMD ID, AP MLD ID, link ID, AP ID, or any combination thereof.

The non-AP device 104-a may perform passive scanning by monitoring a channel on which an AP 102 is operating and by attempting to receive a beacon frame or a broadcast management frame from the AP 102. The non-AP device 104-a may not receive the beacon frame or the broadcast management frame if the non-AP device 104-a is out of range of the AP 102. The non-AP device 104-a may accordingly measure or estimate RSSIs for each channel on which the AP 102 is operating and that the non-AP device 104-a is interested in communicating over.

For example, the non-AP device 104-a may attempt to receive beacon frames or broadcast management frames from each affiliated AP 102 that the non-AP device 104-a is interested in communicating with. Alternatively, or additionally, the non-AP device 104-a may receive the beacon frame or the broadcast management frame from one of the affiliated APs 102 and may estimate reachability (such as by measuring RSSI) for one or more other links 302 of the AP 102 that the non-AP device 104-a is interested in roaming to. Accordingly, the beacon frame or the broadcast management frame transmitted by the AP 102 may include information such as a transmit power with which the beacon frame or the broadcast management frame was transmitted and a transmit power of a beacon frame or a broadcast management frame on the one or more other links 302. The non-AP device 104-a may estimate characteristics of the one or more other links 302 based on pathloss characteristics for the link 302 on which the beacon frame or the broadcast management frame was received.

The non-AP device 104-a may perform active scanning by sending a probe request frame to the AP 102 and receiving a probe response frame from the AP 102. The non-AP device 104-a may not receive the probe response frame if the non-AP device 104-a is out of range from the AP 102. The non-AP device may therefore monitor or estimate RSSIs for each channel on which the AP 102 is operating and that the non-AP device 104-a is interested in roaming to.

For example, the non-AP device 104-a may attempt to receive probe response frames from each affiliated AP 102 that the non-AP device 104-a is interested in roaming to. Alternatively, or additionally, the non-AP device 104-a may receive the probe response frame from one of the affiliated APs 102 and may estimate reachability (RSSI and the like) for one or more other links 302 of the AP 102. Accordingly, the probe response frame transmitted by the AP 102 may include information of a transmit power with which the probe response was transmitted and a transmit power of a probe response transmitted on the one or more other links 302. The non-AP device 104-a may estimate characteristics of the one or more other links 302 based on the pathloss characteristics for the link 302 on which the probe response was received.

In some examples, as part of building the CAMS, the non-AP device 104-a and an AP device (such as the serving AP device 102-a or another AP 102 of the SMD) may perform a frame exchange for preparing links 302 of one or more APs 102 in the SMD for roaming. For example, the non-AP device 104-a may transmit a link preparation request message (such as to the serving AP 102-a or to another AP 102 of the SMD) and may monitor for a link preparation response. In some examples, the non-AP device 104-a may not request the APs 102 to prepare all links of an AP 102. For example, the non-AP device 104-a may be interested in operating on a band associated with a link 302-b of an AP 102-b and not on a band associated with a link 302-c of the AP 102-b. Accordingly, the non-AP device 104-a may not request for the AP 102-b to prepare the link 302-c for roaming. The link preparation request message may accordingly indicate (such as via a per-STA profile subelement in a Basic ML IE in a Neighbor Report element) one or more preferred links of a requested AP MLD.

In some examples, the non-AP device 104-a may not perform informative steps such the informative query or informative roaming after transmitting the link preparation request. For example, the non-AP device 104-a may perform one or more operations after transmitting the link preparation request (such as flushing an uplink queue) rather than performing scanning of links 102 (which may in some implementations include switching channels).

The non-AP device 104-a may transmit the link preparation request message in a first frame (such as a BTM Query frame or a Link Reconfiguration Request frame). The non-AP device 104-a may include a set of suggested or requested APs 102 to be prepared in the request (such as via a BSS Transition Candidate List Entries field indicating a Neighbor Report element for each AP MLD that is of interest and/or via a bitmap indicating one or more APs), or the link preparation request may omit the requested APs 102 (such as an open request without suggestions). For example, the link preparation request message may indicate that the non-AP device 104-a requests to prepare links 302 of the AP 102-b, the AP 102-c, and the AP 102-d for roaming. In some examples, a BTM frame (such as the BSS Transition Management Query frame) may include a category field (such as 1 octet), a Wireless Network Monitoring (WNM) field (such as 1 octet), a Dialog Token frame (such as 1 octet), a BSS Transition Query Reason frame (such as 1 octet), and/or a BSS Transition Candidate List Entries frame (optionally of variable length).

In some examples, the non-AP device 104-a may indicate for the serving AP 102-a to prepare all AP MLDs that are affiliated with the SMD (such as all AP MLDs that were reported via the RNR IE). For example, if the link preparation request message does not include a list of requested AP MLDs (such as the BSS Transition Candidate List Entries field), the non-AP device 104-a may indicate for the serving AP 102-a to prepare all AP MLDs that are affiliated with the SMD. In some examples, an AP 102 (such as the serving AP 102-a or another AP 102 of the SMD) may indicate, to the non-AP device 104-a, a quantity (such as a maximum quantity) of candidate APs 102 that the non-AP device 104-a may request via the link preparation request message. In some examples, a field in the link preparation request message (such as a BSS Transition Query Reason field) may indicate that the link preparation request message is for the link preparation operation.

In some examples, the non-AP device 104-a may indicate (such as via the link preparation request message) an indication of one or more traffic parameters associated with the non-AP device 104-a. For example, the non-AP device 104-a may identify one or more flows (such as via one or more stream classification service (SCS) identifiers (IDs)) or via a single traffic indication aggregated across one or more different flows. Additionally, or alternatively, the non-AP device 104-a may identify, via the link preparation request message, one or more flows that may be satisfied by the network (such as QoS guaranteed flows) and one or more flows that may be deprioritized (such as flows that may not be critical). Accordingly, the serving AP 102-a or the queried AP 102 may identify and prepare one or more links of APs 102 that may satisfy the indicated traffic parameters.

The serving AP 102-a or queried AP 102 may communicate with the other APs 102 of the SMD over the DS 304 or over the air (such as via a request or response) to identify whether the APs 102 may serve the non-AP device 104-a. The serving AP 102-a or queried AP 102 may transmit a link preparation response to the non-AP device 104-a via a response frame (such as a BSS Transition Management Request frame and/or a Link Reconfiguration Response frame indicating a status of the link preparation request for each of the APs 102). The serving AP 102-a or the queried AP 102 may confirm a subset of the requested APs 102 from the link preparation request (such as via one or more Neighbor Report Elements in a BSS Transition Candidate List Entries field and/or a bitmap indicating one or more APs). For example, the link preparation response may indicate that one or more links 302 of the AP 102-b and the AP 102-c are prepared for roaming. In some examples, a BTM frame (such as the BSS Transition Management Request frame) may include a Category field (such as 1 octet), a WNM action field (such as 1 octet), a Dialog Token field (such as 1 octet), a Request Mode field (such as 1 octet), a Dissociation Timer field (such as 2 octets), a Validate Interval field (such as 1 octet), a BSS Termination Duration field (optionally 0 or 12 octets), a Session Information URL field (optionally of variable length), and/or a BSS Transition Candidate List Entries field (optionally of variable length).

The serving AP 102-a or the queried AP 102 may add one or more other APs 102 to a list of “ready” or candidate APs 102 (such as the CAMS). The serving AP 102-a or the queried AP 102 may provide a list of recommended APs 102 in the SMD. In some examples, the link preparation response message may indicate a status of the candidate APs 102. For example, the list may indicate an order of preference for target APs 102 (such as a preference of the network, the DS 304, the SMD, and so on). In some examples, the link preparation response message may include a first value in a field (such as a 0 in a Neighbor Report element) that indicates that one or more AP MLDs are not available for roaming and the non-AP device 104-a may therefore not roam to the one or more AP MLDs. One or more other values of the field (such as 1 to 255) may provide an indication of an order of suitable AP MLDs for the non-AP device 104-a to roam to. For example, a lower value of the field may indicate a less suitable AP MLD (such as an AP MLD that may not support one or more QoS thresholds of the non-AP device 104-a) and a higher value may indicate a relatively more suitable AP MLD. In some examples, the non-AP device 104-a may determine (such as based on a rule defined in a technical specification) that values of the field that are less than a threshold value (such as less than 200) may indicate that the associated AP MLD may accept the non-AP device 104-a but may not support the one or more QoS thresholds.

In some examples, the field in the link preparation response message (such as a Preference field in a BSS Transition Candidate Preference subelement) may indicate a value of a range of values (such as between 1 and 255). The BSS Transition Candidate Preference subelement may include a Subelement ID field (such as 1 octet), a Length field (such as 1 octet), and the Preference field (such as 1 octet). In some examples, a relatively highest value of the range (such as 255) may indicate a most suitable BSS within a candidate list, and one or more decreasing values may indicate one or more BSSs that are associated with corresponding decreasing preferences (such as with equal numbers indicating equal preferences). In some examples, the field may be valid until expiration of a validity interval. In some examples, the serving AP 102-a may indicate zero or more subelements (such as BSS Transition Candidate Preference subelements) in the link preparation response message.

In some examples, the field may be quantized. For example, the range of values may be partitioned into a set of intervals that indicate a level of roaming support for the non-AP device 104-a. The field may accordingly indicate, for a candidate AP 102 (such as a candidate AP 102 associated with a Subelement ID), a value that falls into one of the set of intervals. In some examples, the non-AP device 104-a may determine an interval in which the value falls (such as first level preference information from a network perspective) followed by the value itself (such as second preference information from a network perspective).

As an illustrative example, a first interval may indicate that the associated candidate AP 102 may have one or more resources prepared for roaming and may meet the QoS thresholds of the non-AP device 104-a and may accept the non-AP device 104-a if a roaming request is transmitted (such as for a duration of the validity time). A second interval may indicate that the associated candidate AP 102 may have one or more resources prepared for roaming and may not meet the QoS thresholds of the non-AP device 104-a and may accept the non-AP device 104-a if a roaming request is transmitted (such as for a duration of the validity time). A third interval may indicate that the associated candidate AP 102 may meet the QoS thresholds of the non-AP device 104-a and may accept or reject the non-AP device 104-a if a roaming request is transmitted. A fourth interval may indicate that the associated candidate AP 102 may not meet the QoS thresholds of the non-AP device 104-a and may accept or reject the non-AP device 104-a if a roaming request is transmitted. A fifth interval may indicate that the associated candidate AP 102 may reject the non-AP device 104-a if a roaming request is transmitted.

In some examples, the link preparation response (such as the BSS Transition Candidate Preference subelement) may indicate whether each AP 102 satisfies the one or more QoS thresholds associated with the non-AP device 104-a. Additionally, or alternatively, the link preparation response may indicate a degree of availability of each of the APs 102. For example, an AP 102 may be reported as “ready with QoS guarantee” or “ready without QoS guarantee.” A granularity of the report may be “per link” (such as instead of per AP 102). Key performance indicators (KPIs) considered for the “readiness” may include throughput/latency (such as an estimate of if the AP 102 has enough resources serve a threshold throughput/latency), SCS, QoS, or restricted target wait time (rTWT) schedules. Additionally, or alternatively, the link preparation response may indicate one or more SCS IDs of one or more data flows of the non-AP device 104-a. For example, the link preparation response may indicate which SCS IDs of the non-AP device 104-a each AP 102 is capable of satisfying.

In some examples, the serving AP 102-a or the queried AP 102 may encode information in the link preparation response. For example, the link preparation response may include a bitmap of SCS IDs (or one or more other features), where each bit in the bitmap indicates whether an AP 102 is capable of supporting the respective SCS ID (or another feature).

The serving AP 102-a may transfer a static context (or a portion of static context) of the non-AP device 104-a to the APs 102 of the CAMS (the subset of the SMD). Accordingly, the APs 102 may create and populate data structures and allocate and resources for the potential roaming of the non-AP device 104-a. In some examples, the preparation of resources may initiate before sending the link preparation response. For example, the serving AP 102-a or queried AP 102 may indicate, via the link preparation response, whether one or more of the APs 102 have initiated or completed transfer or storage of at least a portion of the static context. In some examples, the commitment of resources of the APs 102 in CAMS (such as the prepared links) may expire (such as after expiration of a timer).

The static context may include connectivity information such as a MAC address (to identify the non-AP device 104-a), capabilities of the non-AP device 104-a, a target AP MLD MAC address (to identify the target AP 102-b), the target AP MAC addresses (to identify the target AP setup or requested links), a TTLM at the target AP 102-b, security and BA sessions (such as security keys, PTK*, a last downlink serial number (SN) and part number (PN) assigned for each TID (such as with BA session info), a last uplink SN and PN received for each TID (such as with BA session info), or a SN and PN of last uplink MPDU delivered to the gateway), QoS information (such as QoS info or each SCS ID, such as uplink, downlink, and P2P), and the like.

In some examples, the context related to security (such as security keys, PTK, etc.) may be managed by the SMD (such as a higher level logical entity associated with a set of AP MLDs that authenticates and establishes security with the non-AP device 104-a). In some aspects, the AP MLDs may be associated with the SMD. In some aspects, key generation and encryption may be performed by the SMD. In some examples, the SMD may reside in a centralized location and may communicate with the affiliated AP MLDs (such as the AP 102-a, the AP 102-b, the AP 102-c, and the AP 102-d) via backhaul or wireless connections. In such examples, security context of the non-AP device 104-a may not be transferred between the APs 102. That is, the APs 102 may rely on the centralized SMD implementation to operate security functionalities (such as authentication, key generation, encryption, etc.). In some other examples, the SMD may have a distributed implementation (such as instantiated within the APs 102). In such examples, the security context may be transferred between the APs 102, and the security functionalities (such as authentication, key generation, encryption, etc.) may be operated by a respective SMD instantiation within a respective AP 102.

In some examples, an additional frame from the non-AP device 104-a may further narrow down the CAMS provided in the response (such as from the AP 102-b and the AP 102-c to the target AP 102-b). The non-AP device 104-a may transmit the additional frame to the serving AP 102-a. In such examples, the serving AP 102-a may transmit a layer 2 (L2) Ack message to acknowledge the additional frame. In such examples, the serving AP 102-a may initiate the context transfer between the additional frame and the L2 Ack.

Accordingly, one or more messages described herein may indicate zero, one, or more APs 102 that are requested or available for roaming. As a first illustrative example, the non-AP device 104-a may transmit the link preparation request message omitting indication of requested APs 102. The serving AP 102-a or the queried AP 102 may transmit a link preparation response indicating that the non-AP device 104-a may roam to the AP 102-b, the AP 102-c, or the AP 102-b. In some examples, the non-AP device 104-a may transmit the additional frame indicating that the non-AP device 104-a requests to prepare links of the AP 102-b and the AP 102-c (and not the AP 102-d), and the serving AP 102-a or the queried AP 102 may transmit the L2 Ack. In some examples, the non-AP device 104-a may not transmit the additional frame, and the serving AP 102-a or the queried AP 102 may not transmit the L2 Ack.

As a second illustrative example, the non-AP device 104-a may transmit the link preparation request message requesting for preparation of links of the AP 102-b and the AP 102-d. The serving AP 102-a or the queried AP 102 may transmit a link preparation response indicating that the non-AP device 104-a may roam to the AP 102-b or the AP 102-c. In some examples, the non-AP device 104-a may transmit the additional frame indicating that the non-AP device 104-a requests to prepare links of the AP 102-b and the AP 102-c (and not the AP 102-d), and the serving AP 102-a or the queried AP 102 may transmit the L2 Ack. In some examples, the non-AP device 104-a may not transmit the additional frame, and the serving AP 102-a or the queried AP 102 may not transmit the L2 Ack.

The devices of the signaling diagram 300 may use an ML Reconfiguration framework or define a new set of frames for the link preparation request message, the link preparation response, the additional frame, and/or the L2 Ack. For example, the devices of the signaling diagram 300 may use a new mode for the ML Reconfiguration framework, such as an ML Reconfig ADD that enables a target AP 102-b to prepare for the non-AP device 104-a to roam to that client (such as rather than adding a link).

In some examples, a size of the CAMS (such as a maximum size of N APs 102) may be defined. The size N may be a parameter negotiated dynamically within the SMD, and N may be a positive integer. Additionally, or alternatively, the size N may be specified according to a rule in a specification. The size N may be indicated to the non-AP device 104-a as part of an SMD configuration or provided dynamically (such as during the informative query), or may be transparent to the non-AP device 104-a. For example, the serving AP 102-a or the queried AP 102 may prepare and report N APs 102 in the link preparation response frame without indicating the size N to the non-AP device 104-a.

The link preparation request and/or the link preparation response may include a bitmap based on a mapped set of APs 102 (or links 302 of APs 102) within the SMD. For example, an AP 102 of the SMD (such as the serving AP 102-a) may provide a configuration defining a mapping of SMD to AP MLDs to links to the non-AP device 104-a (such as with one bitmap per KPI). Additionally, or alternatively, the link preparation request and/or the link preparation response may be a frame element with one or more subelements, where each subelement may be identified by one or more of SMD ID, AP MLD ID, link ID, or any combination thereof, and may carry the “readiness information” for the set of KPIs of interest in the form of a checkmark, or a value.

For example, the link preparation request, the link preparation response, or both may include one or more R-ML IEs. For example, the link preparation request and/or the link preparation response may include a single R-ML IE that carries multiple Per-STA Profile subelements. Each subelement may correspond to a link 302 that is being requested to be prepared or to a link 302 that is prepared. Each subelement may identify an AP 102 to which the link 302 belongs. Additionally, or alternatively, the link preparation request and/or the link preparation response may include an R-ML IE for each AP 102 that is requested to be prepared or that is prepared. For example, a frilled in a Common Info field of a respective R-ML IE may identify the associated AP 102 and a Per-STA Profile subelement of the R-ML IE may identify a link of the associated AP 102 that is requested to be prepared or that is prepared.

In some examples, the devices of the signaling diagram 300 may perform a frame exchange to roam the non-AP device 104-a to a target AP 102-b within the CAMS. For example, the non-AP device 104-a may transmit a roaming request or initiation frame (such as an RRI) to the serving AP 102-a or to the target AP 102-b. The roaming request may be, for example, a Link Reconfiguration Request frame (such as a frame carrying a Reconfiguration Multi-Link (RML) element). In some examples, a field in the roaming request (such as a MLD AP ID field in a Common Info field of the RML element) may indicate, to the serving AP 102-a, an AP MLD ID of the target AP 102-b. A value of the field may be based on information received in the RNR IE (such as the AP MLD ID indicated in the RNR IE). In some examples (such as if the non-AP device 104-a transmits the roaming request to the target AP 102-b), the roaming request may not include the field indicating the AP MLD ID.

In some examples, the roaming request message may include a subelement (such as a Per-STA Profile subelement) indicating one or more links of the target AP 102-b that the non-AP device 104-a requests to roam to. For example, a first value (such as 15 or all 1s) of a field (such as a Link ID field) of the subelement may indicate that all links of the target AP 102-b are requested. One or more other values (such as a non-15 value) of the field may indicate a subset of links of the target AP 102-b that are requested. For example, the field may indicate Link IDs of the subset of links (such as based on information received by the non-AP device 104-a via the RNR IE). In some examples, a field (such as a Reconfiguration Operation Type field) in the roaming request may indicate an ADD operation to add one or more links of the target AP 102-b.

The serving AP 102-a or the target AP 102-b may respond to the roaming request with a RRR frame (such as a Link Reconfiguration Response Frame) that indicates completion of one or more roaming procedures. The frame exchange may add a subset of APs 102 (or links 302) of the target AP 102-b to the non-AP device 104-a. The frame exchange may be performed between the non-AP device 104-a and the target AP 102-b or the serving AP 102-a. The frame exchange may include a non-AP MLD dynamic context transfer and DS path switching (such as over the DS 304).

The non-AP device 104-a, the target AP 102-b, and/or the serving AP 102-a may leverage an ML Reconfiguration framework or another set of frames for the roaming request and roaming response. In examples in which the non-AP device 104-a, the target AP 102-b, and/or the serving AP 102-a leverage the ML Reconfiguration framework, the non-AP device 104-a, the target AP 102-b, and/or the serving AP 102-a may reuse one or more fields for the frame exchange. In some examples, the serving AP 102-a may identify the target AP 102-b. The non-AP device 104-a may assume a “link add” operation of the ML Reconfiguration is with respect to the currently serving AP 102-a.

Once the non-AP device 104-a has successfully transitioned to the target AP 102-b, the non-AP device 104-a may purge context associated with the serving AP 102-a. For example, the non-AP device 104-a may perform a “link remove” operation to delete one or more links 302-a of the previous serving AP 102-a. For example, the non-AP device 104-a may transmit a frame (such as a Link Reconfiguration Request frame) to the target AP 102-b or to the previous serving AP 102-a. The frame may indicate, to the target AP 102-b, an ID (such as an AP MLD ID received via an RNR IE from the target AP 102-b) associated with the previous serving AP 102-a. In some examples (such as if the non-AP device 104-a transmits the roaming request to the previous serving AP 102-a), the frame may not include the field indicating the AP MLD ID.

In some examples, the frame may include a subelement (such as a Per-STA Profile subelement) indicating one or more links of the previous serving AP 102-a that the non-AP device 104-a requests to remove. For example, a first value (such as 15 or all 1s) of a field (such as a Link ID field) of the subelement may indicate that all links of the previous serving AP 102-a are requested for removal. One or more other values (such as a non-15 value) of the field may indicate a subset of links of the previous serving AP 102-a that are requested for removal. For example, the field may indicate Link IDs of the subset of links (such as based on information received by the non-AP device 104-a via the RNR IE from the target AP 102-b). The “link remove” operation also may include or modify the ML reconfig framework.

In some examples, the APs 102 of the SMD may use some time before the roaming to prepare the data structures, perform initial static context transfer, allocate resources, or the like, for the incoming roaming non-AP device 104-a. Therefore the non-AP device 104-a may identify a “lead time” between the link preparation request or the link preparation response and the roaming request. For example, the non-AP device 104-a may transmit the RAI a time T_prep before a roaming point, and the roaming may not be performed before T_prep after the link preparation request or the link preparation response (such as with initiation or completion of CAMS building as a reference time). The time T_prep may be signaled by each AP 102 individually (such as in one or more beacon frames). The timer T_prep may be provided by the serving AP 102-a as part of an SMD configuration provided to the non-AP device 104-a. The timer T_prep may be provided by the serving AP 102-a as part of the link preparation response or informative query response. The timer T_prep may be defined according to a rule in a specification (such as 10 ms).

In some examples, the APs 102 may not allocate resources for the non-AP device 104-a indefinitely. Accordingly, the APs 102 may identify a “timeout” (such as an expiration time) for the commitment of resources from the APs 102 of the CAMS. For example, the non-AP device 104-a may initiate the roaming before a time T_resource_hold after building the CAMS (such as with initiation or completion of CAMS building as a reference time). The time T_resource_hold may be a time during which the list of candidate APs 102 indicated in the link preparation response frame is valid (such as how long one or more resources may be held by the candidate AP MLDs to meet one or more QoS thresholds of the non-AP device 104-a if the non-AP device 104-a were to roam to the candidate AP MLDs). The time T_resource_hold may be signaled by each AP 102 individually (such as in a beacon frame). The time T_resource_hold may be provided by the serving AP 102-a as part of an SMD configuration that is provided to the non-AP device 104-a. The timer T_resource_hold may be provided by the serving AP MLD as part of the link preparation response (such as via a Validity Interval field in the BTM request frame) or informative query response. The timer T_resource_hold may be defined according to a rule in a specification (such as 10 ms). In some examples, T_resource_hold and T_prep may be timers initiated by the non-AP device 104-a after transmitting the link preparation request or after receiving the link preparation response. As described herein, a time between T_Prep and T_resource_hold may be defined as a roaming interval or a prepared link validity duration.

In some examples, the link preparation frame exchange (such as the link preparation request and link preparation response) may not add a link to an ML configuration. To perform the link preparation frame exchange, the non-AP device 104-a, the serving AP 102-a, or the queried AP 102 may consider one or more QoS parameters (such as requirements) of the non-AP device 104-a. Accordingly, seamless roaming may not disrupt QoS of one or more flows of the non-AP device 104-a. In some examples, the non-AP device 104-a, the serving AP 102-a, or the queried AP 102 may identify one or more timers (such as timers defining T_resource_hold and T_prep defining a roaming interval during which the non-AP device 104-a may initiate roaming). In some examples, the signaling described herein (such as the link preparation request, the link preparation response, the RRI, and the RRR) may include techniques to identify one or more MLDs (such as AP MLDs) via a ML Reconfiguration IE.

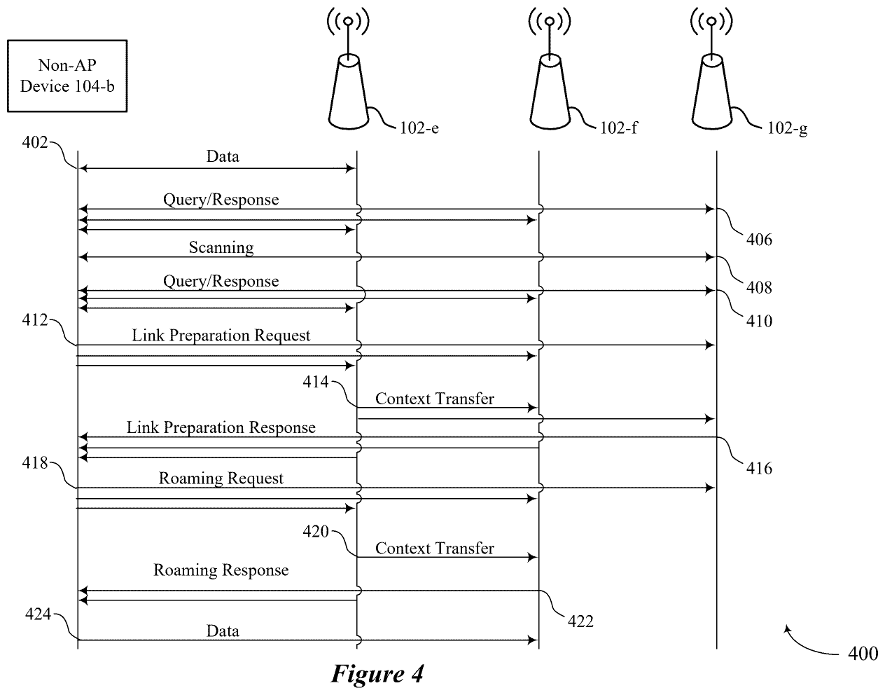

FIG. 4 shows an example of a process flow 400 that supports techniques for roaming using candidate access point mobility sets. The process flow 400 may implement or may be implemented by aspects of the wireless communication network 100, the PPDU 200, or the signaling diagram 300. For example, the process flow 400 may implement or may be implemented by a non-AP device 104-b (such as a wireless device, a non-AP STA 104, a non-AP MLD) and one or more APs 102 (such as AP MLDs in a DS, an AP STA, an AP MLD), which may be examples of the corresponding devices as described with reference to FIG. 1. In some examples, the process flow may include an AP 102-e, and AP 102-f, and an AP 102-g, which may be examples of AP MLDs in a DS.

In the following description of the process flow 400, the operations between the non-AP device 104-b, the AP 102-e, the AP 102-f, and the AP 102-g may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 402, the non-AP device 104-b may be in communication with an AP device 102-e (such as a serving AP, an AP MLD). For example, the non-AP device 104-b may exchange data with the AP 102-e. In some examples, the non-AP device 104-b may receive one or more RNR IEs from the AP 102-e indicating information related to one or more other AP MLDs (such as an AP MLD ID and/or whether the one or more other AP MLDs are associated with a same SMD as the AP 102-e). At 404, the non-AP device 104-b may perform an informative query for readiness of resources of one or more other AP MLDs (such as the AP 102-f, the AP 102-g). For example, the non-AP device 104-b may transmit a query to the AP 102-e, the AP 102-f, and/or the AP 102-g for information associated with the AP 102-f and/or the AP 102-g (such as APs 102 that share a same mobility domain, such as the SMD, as the AP 102-e). The AP 102-e, the AP 102-f, and/or the AP 102-g may respond by transmitting a query response indicating which of the AP 102-f and/or the AP 102-g the non-AP device 104-b may roam to. The informative query may be, for example, an ML probe, a BTM query, or a Neighbor Report Request. The query response may be an ML probe response, a BTM query response, or a Neighbor Report (such as an RNR).

At 406, the non-AP device 104-b may measure one or more received signal strength indicators (RSSIs) associated with the AP 102-f and/or the AP 102-g (such as and one or more other APs 102 in the SMD). For example, the non-AP device 104-b may monitor for one or more beacon frames or one or more broadcast management frames from the AP 102-f and/or the AP 102-g. Additionally, or alternatively, the non-AP device 104-b may transmit a probe request frame to the AP 102-f and/or the AP 102-g and may monitor for a probe response frame from the AP 102-f and/or the AP 102-g. The non-AP device 104-b may measure RSSIs of each of the broadcast management frames, beacon frames, and/or probe response frames. The RSSI measurement procedure may be informed by the informative query of 404.

At 408, the non-AP device 104-b may perform an informative query for readiness of resources of the AP 102-f and/or the AP 102-g. For example, the non-AP device 104-b may transmit a query to the AP 102-e, the AP 102-f, and/or the AP 102-g for information associated with the AP 102-f and/or the AP 102-g. The AP 102-e, the AP 102-f, and/or the AP 102-g may respond by transmitting a query response indicating which of the one or more second AP devices the non-AP device 104-b may roam to. The informative query may be informed by the RSSI measurement procedure. The informative query may be, for example, an ML probe, a BTM query, or a Neighbor Report Request. The query response may be an ML probe response, a BTM query response, or a Neighbor Report (such as an RNR).

At 410, the non-AP device 104-b may transmit a link preparation request message to the AP 102-e, the AP 102-f, and/or the AP 102-g. The link preparation request message may include a request for the AP 102-e, the AP 102-f, and/or the AP 102-g to prepare the AP 102-f and/or the AP 102-g (such as and/or one or more additional APs 102) for roaming from the AP 102-e to at least one of the AP 102-f or the AP 102-g.

In some examples, the link preparation request may include an indication of one or more requested AP devices (such as the AP 102-f and/or the AP 102-g based on the RSSI measurements) or may omit an indication of one or more requested AP devices. In some examples, the link preparation request message may include a bitmap indicating AP 102-f and/or the AP 102-g. The link preparation message may be a version of a Link Reconfiguration Request frame, a BTM Query frame, or another frame. The link preparation request message may include one or more R-ML IEs that indicate one or more other APs 102 (such as AP MLD IDs of AP MLDs or each link of other AP MLDs) that the non-AP device 104-b requests to prepare. The frame may include one or more other elements and fields.

At 414, the AP 102-e may communicate with the AP 102-f and/or the AP 102-g to initiate transfer of at least a portion of context information of the non-AP device 104-b from the AP 102-e to the AP 102-f and/or the AP 102-g based at least in part on the link preparation request message. The context information may include connectivity information such as a MAC address (to identify the non-AP device 104-b), capabilities of the non-AP device 104-b, a target AP MLD MAC address (to identify the target AP 102-f), the target AP MAC addresses (to identify the target AP setup or requested links), a TTLM at the target AP 102-b, security and BA sessions (such as security keys, PTK*, a last downlink serial number (SN) and part number (PN) assigned for each TID (such as with BA session info), a last uplink SN and PN received for each TID (such as with BA session info), or a SN and PN of last uplink MPDU delivered to the gateway), QoS information (such as QoS info or each SCS ID, such as uplink, downlink, and P2P), and the like.

In some examples, the AP 102-e may transfer a first portion of the context to the AP 102-f and/or the AP 102-g at 412 and a second portion of the context to a selected AP 102 (such as the AP 102-f) at another step (such as 320). In some examples, the link preparation response may include a bitmap indicating the AP 102-f and/or the AP 102-g. In some examples (such as if the non-AP device 104-b transmits the link preparation request message to the AP 102-f or the AP 102-g), the AP 102-f and/or the AP 102-g may request for the AP 102-e to transfer the context to the AP 102-f and/or the AP 102-g. The AP 102-e may transfer the context in response to the request.

At 416, the AP 102-e, the AP 102-f, and/or the AP 102-g may transmit a link preparation response indicating a set of one or more second APs 102 (such as the AP 102-f and/or the AP 102-g) that have reserved one or more resources for the roaming and/or that have initiated or completed a transfer of the context of the non-AP device 104-b. For example, upon receiving the link preparation request message, the AP 102-e may transmit the link preparation response via an affiliated AP 102. The link preparation response message may be a version of a Link Reconfiguration Response frame and/or a BTM Request frame carrying an indication of one or more links that are prepared or another frame. The frame may include one or more Basic Multi-Link elements carrying an indication of the links that are prepared. In some examples, the link preparation response message may indicate a preference for the non-AP device 104-b to roam to the one or more second APs 102, one or more additional APs 102 that the non-AP device 104-b may not roam to, and the like.

The frame may include one or more other elements and fields. In some examples, a size of the set of one or more second APs 102 may be defined according to a rule. Additionally, or alternatively, the AP 102-e, the AP 102-f, and/or the AP 102-g may communicate (such as via the DS) to negotiate a size of the set of one or more second APs 102. The set of one or more second APs 102 may include one or more APs 102 that have reserved one or more resources for the non-AP device 104-b to perform roaming (and/or that have initiated or completed a transfer or storing of the context of the non-AP device 104-b).

At 418, the non-AP device 104-b may transmit a roaming request message (such as a roaming initiation (RAI) message) to the AP 102-e, the AP 102-f, and/or the AP 102-g indicating at least one target AP 102 of the set of one or more second APs 102 (such as the AP 102-f) for which the non-AP device 104-b requests to perform the roaming. In some examples, the non-AP device 104-b may transmit the roaming request message during a roaming interval that lasts from a first threshold time after transmitting the link preparation request message or receiving the link preparation response until a second threshold time after transmitting the link preparation request message or receiving the link preparation response. In some examples, the first threshold time may be 0.

In some examples, the non-AP device 104-b may transmit the roaming request message to a same AP 102 as the AP 102 to which the non-AP device 104-b transmitted the link preparation request message. In some examples, the non-AP device 104-b may transmit the roaming request message to a different AP 102 from the AP 102 to which the non-AP device 104-b transmitted the link preparation request message. For example, the non-AP device 104-b may transmit the link preparation request message to a serving AP (such as the AP 102-e), a target AP (such as the AP 102-f), or another AP 102 in the SMD. The non-AP device 104-b may transmit the roaming request to the serving AP (such as the AP 102-e) or to the target AP (such as the AP 102-f).

At 420, the AP 102-e may perform a context transfer to transfer the context (such as the second portion of the context) of the non-AP device 104-b to the requested target AP 102 (such as the AP 102-f) based on receiving the roaming request message. In some examples (such as if the non-AP device 104-b transmits the roaming request to the AP 102-f), the AP 102-f may request for the AP 102-e to transfer the context to the AP 102-f. The AP 102-e may transfer the context in response to the request.

At 422, the non-AP device 104-b may receive a roaming response from the AP 102-e and/or the AP 102-f. In some examples, the non-AP device 104-b may receive data from the AP 102-e. For example, the non-AP device 104-b may receive information indicating for the non-AP device 104-b to perform roaming to switch from communicating with the AP 102-e to the AP 102-f. The AP 102-e may perform a DS path switching procedure to transfer a serving AP of the non-AP device 104-b from being the AP 102-b to being a link of the AP 102-f.

The non-AP device 104-b may perform a link remove operation to remove one or more links associated with the AP 102-e in response to the roaming response message and may begin communication with the AP 102-f. For example, at 424, the non-AP device 104-b may communicate data with the AP 102-f or the AP 102-e. For example, the non-AP device 104-b may transmit a Link Reconfiguration Request indicating one or more links of the AP 102-e that are requested for removal.

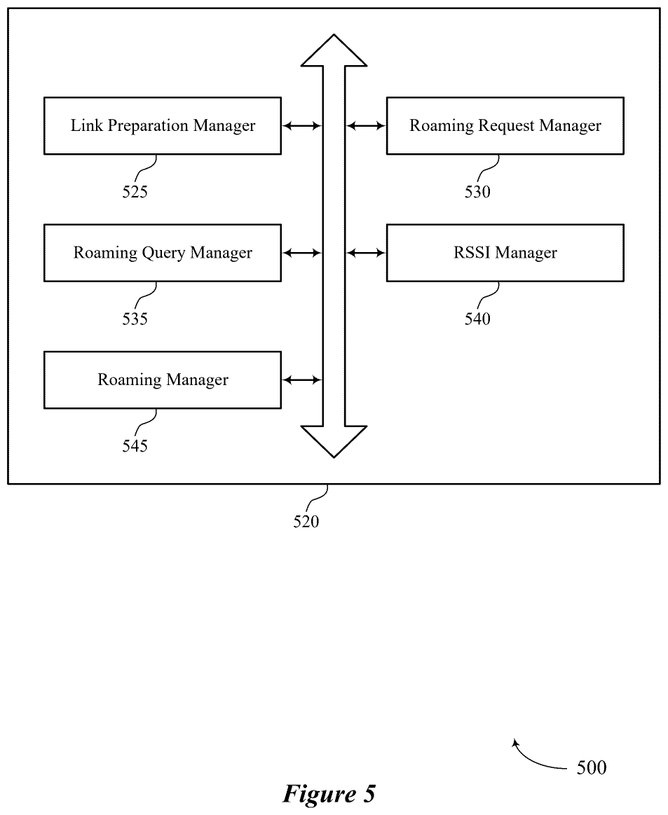

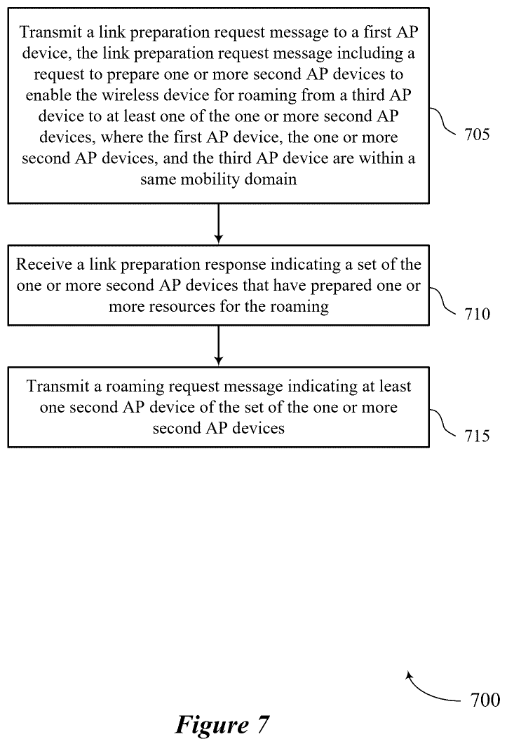

FIG. 5 shows a block diagram of an example wireless communication device 500 that supports techniques for roaming using candidate access point mobility sets. In some examples, the wireless communication device 500 is configured to perform the process 700 described with reference to FIG. 7. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in a STA, such as the STA 104 described with reference to FIG. 1. In some other examples, the wireless communication device 500 can be a STA that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes a user interface (UI) (such as a touchscreen or keypad) and a display, which may be integrated with the UI to form a touchscreen display that is coupled with the processing system. In some examples, the wireless communication device 500 may further include one or more sensors such as, for example, one or more inertial sensors, accelerometers, temperature sensors, pressure sensors, or altitude sensors, that are coupled with the processing system.

The wireless communication device 500 includes a link preparation manager 525, a roaming request manager 530, a roaming query manager 535, an RSSI manager 540, and a roaming manager 545. Portions of one or more of the link preparation manager 525, the roaming request manager 530, the roaming query manager 535, the RSSI manager 540, and the roaming manager 545 may be implemented at least in part in hardware or firmware. For example, one or more of the link preparation manager 525, the roaming request manager 530, the roaming query manager 535, the RSSI manager 540, and the roaming manager 545 may be implemented at least in part by at least a processor or a modem. In some examples, portions of one or more of the link preparation manager 525, the roaming request manager 530, the roaming query manager 535, the RSSI manager 540, and the roaming manager 545 may be implemented at least in part by a processor and software in the form of processor-executable code stored in memory.

The wireless communication device 500 may support wireless communications in accordance with examples as disclosed herein. The link preparation manager 525 is configurable or configured to transmit a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain. In some examples, the link preparation manager 525 is configurable or configured to receive a link preparation response indicating a set of the one or more second AP devices that have prepared one or more resources for the roaming. The roaming request manager 530 is configurable or configured to transmit a roaming request message indicating at least one second AP device of the set of the one or more second AP devices.

In some examples, the roaming query manager 535 is configurable or configured to transmit a query to the first AP device for information associated with the one or more second AP devices. In some examples, the roaming query manager 535 is configurable or configured to receive a query response indicating which of the one or more second AP devices the wireless device can roam to.

In some examples, the query is included in a probe request frame, a multi-link probe request, a basic service set (BSS) transition management (BTM) query frame, or a Neighbor Report Request frame.

In some examples, the query response is included in a probe response frame, multi-link probe response, BTM Request frame, or a Neighbor Report Response frame.

In some examples, the RSSI manager 540 is configurable or configured to measure one or more received signal strength indicators associated with the one or more second AP devices, where the link preparation request message is transmitted based on the measured one or more received signal strength indicators.

In some examples, the RSSI manager 540 is configurable or configured to estimate one or more additional received signal strength indicators associated with the one or more second AP devices based on the measured one or more received signal strength indicators.

In some examples, to support measuring the one or more received signal strength indicators, the RSSI manager 540 is configurable or configured to monitor for one or more beacon frames or one or more broadcast management frames from the one or more second AP devices.

In some examples, to support measuring the one or more received signal strength indicators, the RSSI manager 540 is configurable or configured to transmit one or more probe request frames to the one or more second AP devices. In some examples, to support measuring the one or more received signal strength indicators, the RSSI manager 540 is configurable or configured to receive one or more probe responses from the one or more second AP devices.

In some examples, the roaming request manager 530 is configurable or configured to receive a roaming response from the third AP device or from the at least one second AP device of the set of the one or more second AP devices.

In some examples, the roaming manager 545 is configurable or configured to perform a link remove operation to remove one or more links associated with the third AP device in response to the roaming response.

In some examples, the roaming response is a Link Reconfiguration Response frame indicating acceptance or rejection of the at least one second AP device of the set of the one or more second AP devices. In some examples, the link preparation request message identifies the one or more second AP devices. In some examples, a size of the set of the one or more second AP devices is defined according to a rule. In some examples, the link preparation request message, the link preparation response, or both include a bitmap indicating the one or more second AP devices. In some examples, the link preparation request message omits identification of the one or more second AP devices. In some examples, the first AP device is a same AP device as the third AP device. In some examples, the first AP device is one of the one or more second AP devices. In some examples, the first AP device is the at least one second AP device of the set of the one or more second AP devices.

In some examples, to support transmitting the roaming request message, the roaming request manager 530 is configurable or configured to transmit the roaming request message to the third AP device.

In some examples, to support transmitting the roaming request message, the roaming request manager 530 is configurable or configured to transmit the roaming request message to the at least one second AP device of the one or more second AP devices.

In some examples, to support transmitting the roaming request message, the roaming request manager 530 is configurable or configured to transmit the roaming request message during a roaming interval, where the roaming interval starts a first threshold time after transmitting the link preparation request message or after receiving the link preparation response and ends a second threshold time after transmitting the link preparation request message or after receiving the link preparation response.

In some examples, the link preparation request message is a Link Reconfiguration Request frame that requests for the first AP device to prepare the one or more second AP devices for roaming.

In some examples, the link preparation response is a Link Reconfiguration Response frame that includes a status of link preparation for each of the one or more second AP devices in response to the Link Reconfiguration Request frame.

In some examples, the roaming request message is a Link Reconfiguration Request frame that requests to add one or more links of the at least one second AP device of the set of the one or more second AP devices.

In some examples, the link preparation response indicates that the set of the one or more second AP devices satisfy one or more quality of service thresholds associated with the wireless device, where in the link preparation response indicates an additional set of the one or more second AP devices that do not satisfy the one or more quality of service thresholds.

In some examples, the link preparation response indicates a degree of availability of the set of the one or more second AP devices. In some examples, the link preparation response indicates one or more stream classification service identifiers of one or more data flows associated with the wireless device that a respective one of the set of the one or more second AP devices is capable of satisfying. In some examples, the first AP device, the third AP device, the one or more second AP devices, or any combination thereof are an AP multi-link device or an AP station. In some examples, the wireless device is a non-AP multi-link device or a non-AP station.

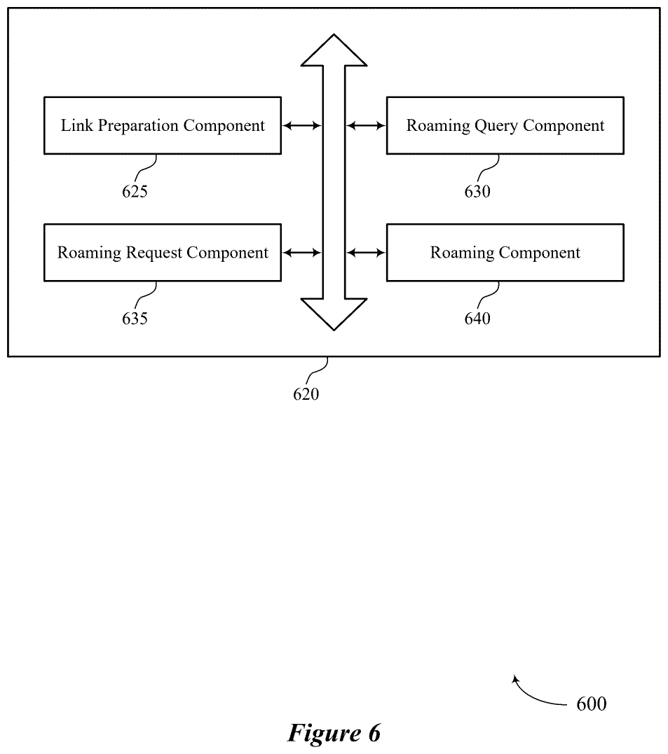

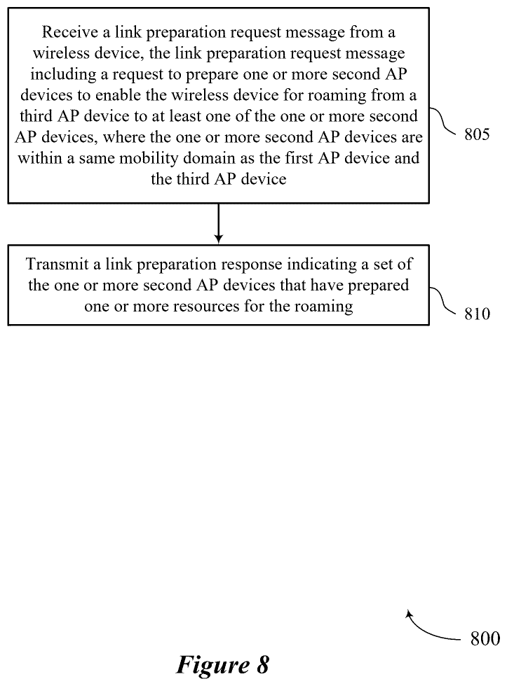

FIG. 6 shows a block diagram of an example wireless communication device 600 that supports techniques for roaming using candidate access point mobility sets. In some examples, the wireless communication device 600 is configured to perform the process 800 described with reference to FIG. 8. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in an AP, such as the AP 102 described with reference to FIG. 1. In some other examples, the wireless communication device 600 can be an AP that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes at least one external network interface coupled with the processing system that enables communication with a core network or backhaul network that enables the wireless communication device 600 to gain access to external networks including the Internet.

The wireless communication device 600 includes a link preparation component 625, a roaming query component 630, a roaming request component 635, and a roaming component 640. Portions of one or more of the link preparation component 625, the roaming query component 630, the roaming request component 635, and the roaming component 640 may be implemented at least in part in hardware or firmware. For example, one or more of the link preparation component 625, the roaming query component 630, the roaming request component 635, and the roaming component 640 may be implemented at least in part by at least a processor or a modem. In some examples, portions of one or more of the link preparation component 625, the roaming query component 630, the roaming request component 635, and the roaming component 640 may be implemented at least in part by a processor and software in the form of processor-executable code stored in memory.

The wireless communication device 600 may support wireless communications in accordance with examples as disclosed herein. The link preparation component 625 is configurable or configured to receive a link preparation request message from a wireless device, the link preparation request message including a request to prepare one or more second AP devices to enable the wireless device for roaming from a third AP device to at least one of the one or more second AP devices, where the one or more second AP devices are within a same mobility domain as the first AP device and the third AP device. In some examples, the link preparation component 625 is configurable or configured to transmit a link preparation response indicating a set of the one or more second AP devices that have prepared one or more resources for the roaming.

In some examples, the first AP device is one of the one or more second AP devices. In some examples, the roaming component 640 is configurable or configured to transmit, to the third AP device, a context transfer request for the third AP device to transfer context information of the wireless device from the third AP device to the set of the one or more second AP devices based on the link preparation request message. In some examples, the first AP device is a same AP device as the third AP device.

In some examples, the roaming component 640 is configurable or configured to perform a context transfer to transfer context information of the wireless device from the third AP device to the set of the one or more second AP devices based on the link preparation request message, where the link preparation response indicates that the third AP device has initiated transfer or completed transfer of at least a first portion of the context information of the wireless device to the set of the one or more second AP devices or that the set of the one or more second AP devices have initiated storage or completed storage of at least the first portion of the context information of the wireless device.

In some examples, the roaming query component 630 is configurable or configured to receive a query from the wireless device for information associated with the one or more second AP devices. In some examples, the roaming query component 630 is configurable or configured to transmit a query response indicating which of the one or more second AP devices the wireless device can roam to.

In some examples, the query is included in a probe request frame, a multi-link probe request, a BTM query frame, or a Neighbor Report Request frame. In some examples, the query response is included in a probe response frame, a multi-link probe response, a BTM Request frame, or a Neighbor Report Response frame.

In some examples, the roaming request component 635 is configurable or configured to receive a roaming request message indicating at least one second AP device of the set of the one or more second AP devices for which the wireless device requests to perform the roaming.

In some examples, the first AP device is the at least one second AP device of the set of the one or more second AP devices.

In some examples, the roaming request component 635 is configurable or configured to perform a DS path switching procedure to transfer a serving AP of the wireless device from the third AP device to the at least one second AP device of the set of the one or more second AP devices in response to the roaming request message.

In some examples, the roaming request component 635 is configurable or configured to perform a context transfer to transfer context information of the wireless device from the third AP device to the at least one second AP device of the set of the one or more second AP devices for which the wireless device requests to perform the roaming based on the roaming request message.

In some examples, the roaming request component 635 is configurable or configured to transmit, to the third AP device, a context transfer request for the third AP device to transfer context information of the wireless device from the third AP device to the at least one second AP device of the set of the one or more second AP devices based on the roaming request message.

In some examples, to support receiving the roaming request message, the roaming request component 635 is configurable or configured to receive the roaming request message during a roaming interval, where the roaming interval starts a first threshold time after the link preparation request message is received or after the link preparation response is transmitted and ends a second threshold time after the link preparation request message is received or after the link preparation response is transmitted.

In some examples, the roaming request message is a Link Reconfiguration Request frame that requests to add one or more links of at least one second AP device of the set of the one or more second AP devices. In some examples, the link preparation request message is a Link Reconfiguration Request frame that requests for the first AP device to prepare the one or more second AP devices for roaming.

In some examples, the link preparation response is a Link Reconfiguration Response frame that includes a status of link preparation for each of the one or more second AP devices in response to the Link Reconfiguration Request frame. In some examples, the link preparation request message identifies the one or more second AP devices. In some examples, a size of the set of the one or more second AP devices is defined according to a rule.

In some examples, the link preparation component 625 is configurable or configured to communicate with the one or more second AP devices, where a size of the set of the one or more second AP devices is based on the communication with the one or more second AP devices. In some examples, the link preparation request message, the link preparation response, or both include a bitmap indicating the one or more second AP devices. In some examples, the link preparation request message omits identification of the one or more second AP devices.

In some examples, the link preparation response indicates that the set of the one or more second AP devices satisfy one or more quality of service thresholds associated with the wireless device, where in the link preparation response indicates an additional set of the one or more second AP devices that do not satisfy the one or more quality of service thresholds.

In some examples, the link preparation response indicates a degree of availability of the set of the one or more second AP devices. In some examples, the link preparation response indicates one or more stream classification service identifiers of one or more data flows associated with the wireless device that a respective one of the set of the one or more second AP devices is capable of satisfying.

In some examples, the first AP device, the third AP device, the one or more second AP devices, or any combination thereof are AP multi-link devices or AP stations. In some examples, the wireless device is a non-AP multi-link device or a non-AP station.

FIG. 7 shows a flowchart illustrating an example process 700 performable by or at a wireless device that supports techniques for roaming using candidate access point mobility sets. The operations of the process 700 may be implemented by a wireless device or its components as described herein. For example, the process 700 may be performed by a wireless communication device, such as the wireless communication device 500 described with reference to FIG. 5, operating as or within a wireless STA. In some examples, the process 700 may be performed by a wireless STA, such as one of the STAs 104 described with reference to FIG. 1.

In some examples, in 705, the wireless device may transmit a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain. The operations of 705 may be performed in accordance with examples as disclosed herein. In some implementations, aspects of the operations of 705 may be performed by a link preparation manager 525 as described with reference to FIG. 5.

In some examples, in 710, the wireless device may receive a link preparation response indicating a set of the one or more second AP devices that have prepared one or more resources for the roaming. The operations of 710 may be performed in accordance with examples as disclosed herein. In some implementations, aspects of the operations of 710 may be performed by a link preparation manager 525 as described with reference to FIG. 5.

In some examples, in 715, the wireless device may transmit a roaming request message indicating at least one second AP device of the set of the one or more second AP devices. The operations of 715 may be performed in accordance with examples as disclosed herein. In some implementations, aspects of the operations of 715 may be performed by a roaming request manager 530 as described with reference to FIG. 5.

FIG. 8 shows a flowchart illustrating an example process 800 performable by or at a first AP device that supports techniques for roaming using candidate access point mobility sets. The operations of the process 800 may be implemented by a first AP device or its components as described herein. For example, the process 800 may be performed by a wireless communication device, such as the wireless communication device 600 described with reference to FIG. 6, operating as or within a wireless AP. In some examples, the process 800 may be performed by a wireless AP, such as one of the APs 102 described with reference to FIG. 1.

In some examples, in 805, the first AP device may receive a link preparation request message from a wireless device, the link preparation request message including a request to prepare one or more second AP devices to enable the wireless device for roaming from a third AP device to at least one of the one or more second AP devices, where the one or more second AP devices are within a same mobility domain as the first AP device and the third AP device. The operations of 805 may be performed in accordance with examples as disclosed herein. In some implementations, aspects of the operations of 805 may be performed by a link preparation component 625 as described with reference to FIG. 6.

In some examples, in 810, the first AP device may transmit a link preparation response indicating a set of the one or more second AP devices that have prepared one or more resources for the roaming. The operations of 810 may be performed in accordance with examples as disclosed herein. In some implementations, aspects of the operations of 810 may be performed by a link preparation component 625 as described with reference to FIG. 6.

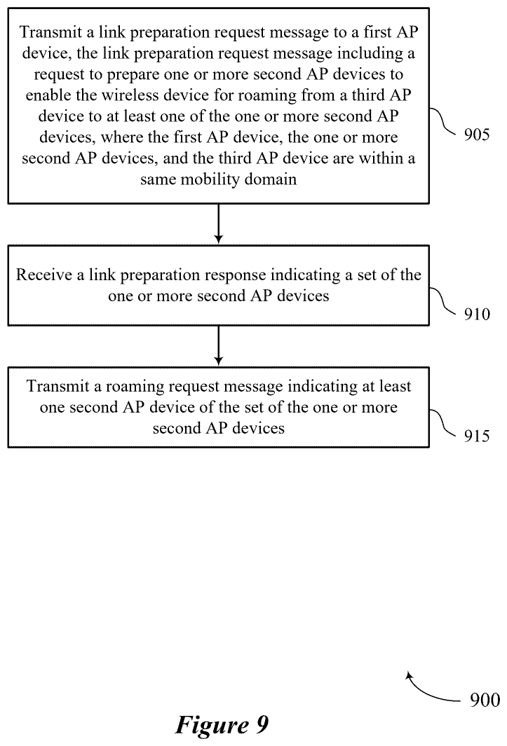

FIG. 9 shows a flowchart illustrating an example process 900 performable by or at a wireless device that supports techniques for roaming using candidate access point mobility sets. The operations of the process 900 may be implemented by a wireless device or its components as described herein. For example, the process 900 may be performed by a wireless communication device, such as the wireless communication device 500 described with reference to FIG. 5, operating as or within a wireless STA. In some examples, the process 900 may be performed by a wireless STA, such as one of the STAs 104 described with reference to FIG. 1.

In some examples, in 905, the wireless device may transmit a link preparation request message to a first AP device, the link preparation request message including a request to prepare one or more second AP devices to enable the wireless device for roaming from a third AP device to at least one of the one or more second AP devices, where the first AP device, the one or more second AP devices, and the third AP device are within a same mobility domain. The operations of 905 may be performed in accordance with examples as disclosed herein. In some implementations, aspects of the operations of 905 may be performed by a link preparation manager 525 as described with reference to FIG. 5.

In some examples, in 910, the wireless device may receive a link preparation response indicating a set of the one or more second AP devices. The operations of 910 may be performed in accordance with examples as disclosed herein. In some implementations, aspects of the operations of 910 may be performed by a link preparation manager 525 as described with reference to FIG. 5.

In some examples, in 915, the wireless device may transmit a roaming request message indicating at least one second AP device of the set of the one or more second AP devices. The operations of 915 may be performed in accordance with examples as disclosed herein. In some implementations, aspects of the operations of 915 may be performed by a roaming request manager 530 as described with reference to FIG. 5.

Implementation examples are described in the following numbered clauses:

The following provides an overview of aspects of the present disclosure:

Aspect 1: A method by a wireless device, comprising: a processing system that includes processor circuitry and memory circuitry that stores code, the processing system configured to cause the wireless device to: transmitting a preparation request message (such as a link preparation request message) to a first AP device, the preparation request message including a request to prepare a second AP device (such as one or more second AP devices) to enable the wireless device for roaming from a third AP device to at least one of the one or more second AP devices, wherein the first AP device, the one or more second AP devices, and the third AP device are within a same mobility domain; receiving a preparation response (such as a link preparation response) indicating that the second AP device has prepared one or more resources for the roaming (such as a set of the one or more second AP devices that have prepared one or more resources for the roaming); and transmitting a roaming request message indicating the second AP (such as at least one second AP device of the set of the one or more second AP devices).

Aspect 2: The method of aspect 1, further comprising: receiving a RNR information element that indicates the one or more second AP devices.

Aspect 3: The method of aspect 2, wherein the RNR information element indicates that the one or more second AP devices are within the same mobility domain.

Aspect 4: The method of any of aspects 2 through 3, wherein the RNR information element indicates a MLD ID, a link ID, or both associated with the one or more second AP devices.

Aspect 5: The method of any of aspects 1 through 4, further comprising: transmitting a query to the first AP device for information associated with the one or more second AP devices; and receiving a query response indicating which of the one or more second AP devices the wireless device can roam to.

Aspect 6: The method of aspect 5, wherein the query is included in a probe request frame, a ML probe request, a BTM query frame, or a Neighbor Report Request frame.

Aspect 7: The method of any of aspects 5 through 6, wherein the query response is included in a probe response frame, ML probe response, BTM Request frame, or a Neighbor Report Response frame.

Aspect 8: The method of any of aspects 1 through 7, further comprising: measuring one or more received signal strength indicators associated with the one or more second AP devices, wherein the preparation request message is transmitted based at least in part on the measured one or more received signal strength indicators.

Aspect 9: The method of aspect 8, further comprising: estimating one or more additional received signal strength indicators associated with the one or more second AP devices based at least in part on the measured one or more received signal strength indicators.

Aspect 10: The method of any of aspects 8 through 9, wherein measuring the one or more received signal strength indicators comprises: monitoring for one or more beacon frames or one or more broadcast management frames from the one or more second AP devices.

Aspect 11: The method of any of aspects 8 through 10, wherein measuring the one or more received signal strength indicators comprises: transmitting one or more probe request frames to the one or more second AP devices; and receiving one or more probe responses from the one or more second AP devices.

Aspect 12: The method of any of aspects 1 through 11, wherein the preparation request message comprises a BTM query frame.

Aspect 13: The method of aspect 12, wherein the preparation request message, the preparation response, or both comprise a bitmap indicating the one or more second AP devices.

Aspect 14: The method of any of aspects 12 through 13, wherein the preparation request message indicates the one or more second AP devices.

Aspect 15: The method of aspect 12, wherein the preparation request message omits identification of the one or more second AP devices.

Aspect 16: The method of any of aspects 1 through 15, wherein the preparation response comprises a BTM request frame.

Aspect 17: The method of aspect 16, wherein the preparation response comprises one or more Neighbor Report elements indicating a preparation status of the one or more second AP devices.

Aspect 18: The method of aspect 17, wherein the preparation status of the one or more second AP devices comprises one or more preferences associated with roaming to each AP devices of the set of the one or more second AP devices.

Aspect 19: The method of aspect 18, wherein the one or more preferences associated with roaming to each AP device of the set of the one or more second AP devices are associated with one or more preference intervals, each preference interval of the one or more preference intervals is associated with a level of support for roaming to a corresponding AP device.

Aspect 20: The method of any of aspects 17 through 19, wherein the preparation status indicates one or more AP devices that are unavailable for roaming.

Aspect 21: The method of any of aspects 1 through 20, wherein the preparation response indicates that the set of the one or more second AP devices satisfy one or more quality of service thresholds associated with the wireless device, where in the preparation response indicates an additional set of the one or more second AP devices that do not satisfy the one or more quality of service thresholds.

Aspect 22: The method of any of aspects 1 through 21, wherein the preparation response indicates a degree of availability of the set of the one or more second AP devices.

Aspect 23: The method of any of aspects 1 through 22, wherein the preparation response indicates one or more SCS IDs of one or more data flows associated with the wireless device that a respective one of the set of the one or more second AP devices is capable of satisfying.

Aspect 24: The method of any of aspects 1 through 23, wherein transmitting the roaming request message comprises: transmitting the roaming request message during a roaming interval, wherein the roaming interval starts (e.g., a first threshold time) after transmitting the preparation request message or after receiving the preparation response and ends (e.g., a second threshold time) after transmitting the preparation request message or after receiving the preparation response.

Aspect 25: The method of aspect 24, wherein the preparation response comprises an indication of a duration of the roaming interval, the duration corresponds to a time during which the set of the one or more second AP devices will hold the prepared one or more resources.

Aspect 26: The method of any of aspects 1 through 25, wherein the first AP device is a same AP device as the third AP device.

Aspect 27: The method of any of aspects 1 through 26, wherein the first AP device is one of the one or more second AP devices.

Aspect 28: The method of aspect 27, wherein the first AP device is the at least one second AP device of the set of the one or more second AP devices.

Aspect 29: The method of any of aspects 1 through 28, wherein the roaming request message is a Link Reconfiguration Request frame.

Aspect 30: The method of any of aspects 1 through 29, further comprising: receiving a roaming response from the third AP device or from the at least one second AP device of the set of the one or more second AP devices.

Aspect 31: The method of aspect 30, further comprising: performing a link remove operation to remove one or more links associated with the third AP device in response to the roaming response.

Aspect 32: The method of aspect 31, wherein performing the link remove operation further comprises: transmitting a Link Reconfiguration Request frame to the at least one second AP device of the one or more second AP devices, wherein the Link Reconfiguration Request frame indicates the third AP device.

Aspect 33: The method of aspect 32, wherein the Link Reconfiguration Request frame indicates one or more links associated with the third AP device that are requested for removal.

Aspect 34: The method of any of aspects 30 through 33, wherein the roaming response is a Link Reconfiguration Response frame indicating acceptance or rejection of the at least one second AP device of the set of the one or more second AP devices.

Aspect 35: The method of any of aspects 30 through 34, wherein the roaming response is a Link Reconfiguration Response frame.

Aspect 36: The method of any of aspects 1 through 35, wherein the preparation request message identifies the one or more second AP devices.

Aspect 37: The method of aspect 36, wherein the preparation request message indicates one or more links of the at least one second AP device of the one or more second AP devices that are requested.

Aspect 38: The method of any of aspects 1 through 37, wherein the preparation request message identifies the at least one second AP device of the one or more second AP devices.

Aspect 39: The method of any of aspects 1 through 38, wherein a size of the set of the one or more second AP devices is defined according to a rule.

Aspect 40: The method of any of aspects 1 through 39, wherein transmitting the roaming request message comprises: transmitting the roaming request message to the third AP device.

Aspect 41: The method of any of aspects 1 through 40, wherein transmitting the roaming request message comprises: transmitting the roaming request message to the at least one second AP device of the one or more second AP devices.

Aspect 42: The method of any of aspects 1 through 41, wherein the preparation request message is a Link Reconfiguration Request frame that requests for the first AP device to prepare the one or more second AP devices for roaming.

Aspect 43: The method of aspect 42, wherein the preparation response is a Link Reconfiguration Response frame that comprises a status of link preparation for each of the one or more second AP devices in response to the Link Reconfiguration Request frame.

Aspect 44: The method of any of aspects 1 through 43, wherein the roaming request message is a Link Reconfiguration Request frame that requests to add one or more links of the at least one second AP device of the set of the one or more second AP devices.

Aspect 45: The method of any of aspects 1 through 44, wherein the first AP device, the third AP device, the one or more second AP devices, or any combination thereof are an AP MLD or an AP station.

Aspect 46: The method of any of aspects 1 through 45, wherein the wireless device is a non-AP MLD or a non-AP station.

Aspect 47: A method by a wireless device, comprising: a processing system that includes processor circuitry and memory circuitry that stores code, the processing system configured to cause the wireless device to: transmitting a link preparation request message to a first AP device, the link preparation request message including a request to prepare one or more second AP devices to enable the wireless device for roaming from a third AP device to at least one of the one or more second AP devices, wherein the first AP device, the one or more second AP devices, and the third AP device are within a same mobility domain; receiving a link preparation response indicating a set of the one or more second AP devices; and transmitting a roaming request message indicating at least one second AP device of the set of the one or more second AP devices.

Aspect 48: The method of aspect 47, further comprising: receiving a RNR information element that indicates the one or more second AP devices.

Aspect 49: The method of aspect 48, wherein the RNR information element indicates that the one or more second AP devices are within the same mobility domain.

Aspect 50: The method of any of aspects 48 through 49, wherein the RNR information element indicates a MLD ID, a link ID, or both associated with the one or more second AP devices.

Aspect 51: The method of any of aspects 47 through 50, further comprising: transmitting a query to the first AP device for information associated with the one or more second AP devices; and receiving a query response indicating which of the one or more second AP devices the wireless device can roam to.

Aspect 52: The method of aspect 51, wherein the query is included in a probe request frame, a ML probe request, a BTM query frame, or a Neighbor Report Request frame.

Aspect 53: The method of any of aspects 51 through 52, wherein the query response is included in a probe response frame, ML probe response, BTM Request frame, or a Neighbor Report Response frame.

Aspect 54: The method of any of aspects 47 through 53, wherein the link preparation request message comprises a BTM query frame.

Aspect 55: The method of aspect 54, wherein the link preparation request message indicates the one or more second AP devices.

Aspect 56: The method of any of aspects 54 through 55, wherein the link preparation request message omits identification of the one or more second AP devices.

Aspect 57: The method of any of aspects 47 through 56, wherein the link preparation response comprises a BTM request frame.

Aspect 58: The method of aspect 57, wherein the link preparation response comprises one or more Neighbor Report elements indicating a preparation status of the one or more second AP devices.

Aspect 59: The method of aspect 58, wherein the preparation status of the one or more second AP devices comprises one or more preferences associated with roaming to each AP devices of the set of the one or more second AP devices.

Aspect 60: The method of aspect 59, wherein the one or more preferences associated with roaming to each AP device of the set of the one or more second AP devices are associated with one or more preference intervals, each preference interval of the one or more preference intervals is associated with a level of support for roaming to a corresponding AP device.

Aspect 61: The method of any of aspects 58 through 60, wherein the preparation status indicates one or more AP devices that are unavailable for roaming.

Aspect 62: The method of any of aspects 47 through 61, wherein the link preparation response indicates that the set of the one or more second AP devices satisfy one or more quality of service thresholds associated with the wireless device, where in the link preparation response indicates an additional set of the one or more second AP devices that do not satisfy the one or more quality of service thresholds.

Aspect 63: The method of any of aspects 47 through 62, wherein the link preparation response indicates a degree of availability of the set of the one or more second AP devices.

Aspect 64: The method of any of aspects 47 through 63, wherein the link preparation response indicates one or more SCS IDs of one or more data flows associated with the wireless device that a respective one of the set of the one or more second AP devices is capable of satisfying.

Aspect 65: The method of any of aspects 47 through 64, wherein transmitting the roaming request message comprises: transmitting the roaming request message during a roaming interval, wherein the roaming interval starts a first threshold time after transmitting the link preparation request message or after receiving the link preparation response and ends a second threshold time after transmitting the link preparation request message or after receiving the link preparation response.

Aspect 66: The method of aspect 65, wherein the link preparation response comprises an indication of a duration of the roaming interval, the duration corresponds to a time during which the set of the one or more second AP devices will hold one or more prepared resources.

Aspect 67: The method of any of aspects 47 through 66, wherein the first AP device is a same AP device as the third AP device.

Aspect 68: The method of any of aspects 47 through 66, wherein the first AP device is one of the one or more second AP devices.

Aspect 69: The method of aspect 68, wherein the first AP device is the at least one second AP device of the set of the one or more second AP devices.

Aspect 70: The method of any of aspects 47 through 69, wherein the roaming request message is a Link Reconfiguration Request frame.

Aspect 71: The method of any of aspects 47 through 70, further comprising: transmitting the roaming request message to one of the third AP device or to the at least one second AP device of the set of the one or more second AP devices; and receiving a roaming response from the one of the third AP device or from the at least one second AP device of the set of the one or more second AP devices.

Aspect 72: The method of aspect 71, further comprising: performing a link remove operation to remove one or more links associated with the third AP device in response to the roaming response.

Aspect 73: The method of aspect 72, wherein performing the link remove operation further comprises: transmitting a Link Reconfiguration Request frame to the at least one second AP device of the one or more second AP devices, wherein the Link Reconfiguration Request frame indicates the third AP device.

Aspect 74: The method of aspect 73, wherein the Link Reconfiguration Request frame indicates one or more links associated with the third AP device that are requested for removal.

Aspect 75: The method of any of aspects 71 through 74, wherein the roaming response is a Link Reconfiguration Response frame.

Aspect 76: The method of any of aspects 47 through 75, wherein the link preparation request message identifies the at least one second AP device of the one or more second AP devices.

Aspect 77: The method of aspect 76, wherein the link preparation request message indicates one or more links of the at least one second AP device of the one or more second AP devices that are requested.

Aspect 78: The method of any of aspects 47 through 77, wherein the first AP device, the third AP device, the one or more second AP devices, or any combination thereof are an AP MLD or an AP station.

Aspect 79: The method of any of aspects 47 through 78, wherein the wireless device is a non-AP MLD or a non-AP station.

Aspect 80: A wireless device comprising one or more memories storing processor-executable code, and one or more processors coupled with the one or more memories and individually or collectively operable to execute the code to cause the wireless device to perform a method of any of aspects 1 through 46.

Aspect 81: A wireless device comprising at least one means for performing a method of any of aspects 1 through 46.

Aspect 82: A non-transitory computer-readable medium storing code the code comprising instructions executable by one or more processors to perform a method of any of aspects 1 through 46.

Aspect 83: A wireless device comprising one or more memories storing processor-executable code, and one or more processors coupled with the one or more memories and individually or collectively operable to execute the code to cause the wireless device to perform a method of any of aspects 47 through 79.

Aspect 84: A wireless device comprising at least one means for performing a method of any of aspects 47 through 79.

Aspect 85: A non-transitory computer-readable medium storing code the code comprising instructions executable by one or more processors to perform a method of any of aspects 47 through 79.

Aspect 86: A method for wireless communications at a first AP device, comprising: receiving a link preparation request message from a wireless device, the link preparation request message including a request to prepare one or more second AP devices to enable the wireless device for roaming from a third AP device to at least one of the one or more second AP devices, wherein the one or more second AP devices are within a same mobility domain as the first AP device and the third AP device; and transmitting a link preparation response indicating a set of the one or more second AP devices that have prepared one or more resources for the roaming.

Aspect 87: The method of aspect 86, wherein the first AP device is one of the one or more second AP devices.

Aspect 88: The method of aspect 87, further comprising: transmitting, to the third AP device, a context transfer request for the third AP device to transfer context information of the wireless device from the third AP device to the set of the one or more second AP devices based at least in part on the link preparation request message.

Aspect 89: The method of aspect 86, wherein the first AP device is a same AP device as the third AP device.

Aspect 90: The method of aspect 89, further comprising: performing a context transfer to transfer context information of the wireless device from the third AP device to the set of the one or more second AP devices based at least in part on the link preparation request message, wherein the link preparation response indicates that the third AP device has initiated transfer or completed transfer of at least a first portion of the context information of the wireless device to the set of the one or more second AP devices or that the set of the one or more second AP devices have initiated storage or completed storage of at least the first portion of the context information of the wireless device.

Aspect 91: The method of any of aspects 86 through 90, further comprising: receiving a query from the wireless device for information associated with the one or more second AP devices; and transmitting a query response indicating which of the one or more second AP devices the wireless device can roam to.

Aspect 92: The method of aspect 91, wherein the query is included in a probe request frame, a multi-link probe request, a BTM query frame, or a Neighbor Report Request frame.

Aspect 93: The method of any of aspects 91 through 92, wherein the query response is included in a probe response frame, a multi-link probe response, a BTM Request frame, or a Neighbor Report Response frame.

Aspect 94: The method of any of aspects 86 through 93, further comprising: receiving a roaming request message indicating at least one second AP device of the set of the one or more second AP devices for which the wireless device requests to perform the roaming.

Aspect 95: The method of aspect 94, wherein the first AP device is the at least one second AP device of the set of the one or more second AP devices.

Aspect 96: The method of any of aspects 94 through 95, further comprising: performing a DS path switching procedure to transfer the wireless device from the third AP device to the at least one second AP device of the set of the one or more second AP devices in response to the roaming request message.

Aspect 97: The method of any of aspects 94 through 96, further comprising: performing a context transfer to transfer context information of the wireless device from the third AP device to the at least one second AP device of the set of the one or more second AP devices for which the wireless device requests to perform the roaming based at least in part on the roaming request message.

Aspect 98: The method of any of aspects 94 through 97, further comprising: transmitting, to the third AP device, a context transfer request for the third AP device to transfer context information of the wireless device from the third AP device to the at least one second AP device of the set of the one or more second AP devices based at least in part on the roaming request message

Aspect 99: The method of any of aspects 94 through 98, wherein receiving the roaming request message comprises: receiving the roaming request message during a roaming duration, wherein the roaming duration starts a first threshold time after the link preparation request message is received or after the link preparation response is transmitted and ends a second threshold time after the link preparation request message is received or after the link preparation response is transmitted.

Aspect 100: The method of any of aspects 94 through 99, wherein the roaming request message is a Link Reconfiguration Request frame that requests to add one or more links of at least one second AP device of the set of the one or more second AP devices.

Aspect 101: The method of any of aspects 86 through 100, wherein the link preparation request message is a Link Reconfiguration Request frame that requests for the first AP device to prepare the one or more second AP devices for roaming.

Aspect 102: The method of aspect 101, wherein the link preparation response is a Link Reconfiguration Response frame that comprises a status of link preparation for each of the one or more second AP devices in response to the Link Reconfiguration Request frame.

Aspect 103: The method of any of aspects 86 through 102, wherein the link preparation request message identifies the one or more second AP devices.

Aspect 104: The method of any of aspects 86 through 103, wherein a size of the set of the one or more second AP devices is defined according to a rule.

Aspect 105: The method of any of aspects 86 through 104, further comprising: communicating with the one or more second AP devices, wherein a size of the set of the one or more second AP devices is based at least in part on the communication with the one or more second AP devices.

Aspect 106: The method of any of aspects 86 through 105, wherein the link preparation request message, the link preparation response, or both comprise a bitmap indicating the one or more second AP devices.

Aspect 107: The method of any of aspects 86 through 102 or 104 through 106, wherein the link preparation request message omits identification of the one or more second AP devices.

Aspect 108: The method of any of aspects 86 through 107, wherein the link preparation response indicates that the set of the one or more second AP devices satisfy one or more quality of service thresholds associated with the wireless device, where in the link preparation response indicates an additional set of the one or more second AP devices that do not satisfy the one or more quality of service thresholds.

Aspect 109: The method of any of aspects 86 through 108, wherein the link preparation response indicates a degree of availability of the set of the one or more second AP devices.

Aspect 110: The method of any of aspects 86 through 109, wherein the link preparation response indicates one or more SCS IDs of one or more data flows associated with the wireless device that a respective one of the set of the one or more second AP devices is capable of satisfying.

Aspect 111: The method of any of aspects 86 through 110, wherein the first AP device, the third AP device, the one or more second AP devices, or any combination thereof are AP MLDs or an AP STAs.

Aspect 112: The method of any of aspects 86 through 111, wherein the wireless device is a non-AP MLD or a non-AP STA.

Aspect 113: A first AP device for wireless communications, comprising one or more memories storing processor-executable code, and one or more processors coupled with the one or more memories and individually or collectively operable to execute the code to cause the first AP device to perform a method of any of aspects 86 through 112.

Aspect 114: A first AP device for wireless communications, comprising at least one means for performing a method of any of aspects 86 through 112.

Aspect 115: A non-transitory computer-readable medium storing code for wireless communications, the code comprising instructions executable by one or more processors to perform a method of any of aspects 86 through 112.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,”’ may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
a processing system that includes processor circuitry and memory circuitry that stores code, the processing system configured to cause the wireless device to:
transmit a preparation request message to a first access point (AP) device, the preparation request message including a request to prepare one or more second AP devices to enable the wireless device for roaming from a third AP device to at least one of the one or more second AP devices, wherein the first AP device, the one or more second AP devices, and the third AP device are within a same mobility domain;
receive a preparation response indicating a set of the one or more second AP devices that have prepared one or more resources for the roaming; and
transmit a roaming request message indicating at least one second AP device of the set of the one or more second AP devices.

2. The wireless device of claim 1, wherein the processing system is further configured to cause the wireless device to:
receive neighbor report information that indicates the one or more second AP devices.

3. The wireless device of claim 1, wherein the processing system is further configured to cause the wireless device to:
measure one or more received signal strength indicators associated with the one or more second AP devices, wherein the preparation request message is transmitted based at least in part on the measured one or more received signal strength indicators.

4. The wireless device of claim 3, wherein, to measure the one or more received signal strength indicators, the processing system is configured to cause the wireless device to:
transmit one or more probe request frames to the one or more second AP devices; and
receive one or more probe responses from the one or more second AP devices.

5. The wireless device of claim 1, wherein the preparation request message comprises a basic service set (BSS) transition management (BTM) query frame.

6. The wireless device of claim 1, wherein the preparation response comprises a basic service set (BSS) transition management (BTM) request frame.

7. The wireless device of claim 6, wherein the preparation response comprises one or more Neighbor Report elements indicating a preparation status of the one or more second AP devices.

8. The wireless device of claim 1, wherein the preparation response indicates one or more stream classification service identifiers of one or more data flows associated with the wireless device that a respective one of the set of the one or more second AP devices is capable of satisfying.

9. The wireless device of claim 1, wherein, to transmit the roaming request message, the processing system is configured to cause the wireless device to:
transmit the roaming request message during a roaming interval, wherein the roaming interval starts after transmitting the preparation request message or after receiving the preparation response and ends after transmitting the preparation request message or after receiving the preparation response.

10. The wireless device of claim 9, wherein the preparation response comprises an indication of a duration of the roaming interval, and the duration corresponds to a time during which the set of the one or more second AP devices will hold the prepared one or more resources.

11. The wireless device of claim 1, wherein the first AP device is a same AP device as the third AP device.

12. The wireless device of claim 1, wherein the processing system is further configured to cause the wireless device to:
receive a roaming response from the third AP device or from the at least one second AP device of the set of the one or more second AP devices.

13. The wireless device of claim 1, wherein, to transmit the roaming request message, the processing system is configured to cause the wireless device to:
transmit the roaming request message to the at least one second AP device of the one or more second AP devices.

14. The wireless device of claim 1, wherein the preparation request message is a Link Reconfiguration Request frame that requests for the first AP device to prepare the one or more second AP devices for roaming.

15. The wireless device of claim 14, wherein the preparation response is a Link Reconfiguration Response frame that comprises a status of link preparation for each of the one or more second AP devices in response to the Link Reconfiguration Request frame.

16. The wireless device of claim 1, wherein the roaming request message is a Link Reconfiguration Request frame that requests to add one or more links of the at least one second AP device of the set of the one or more second AP devices.

17. The wireless device of claim 1, wherein the first AP device, the third AP device, the one or more second AP devices, or any combination thereof are an AP multi-link device or an AP station.

18. The wireless device of claim 1, wherein the wireless device is a non-AP multi-link device or a non-AP station.

19. A wireless device, comprising:
a processing system that includes processor circuitry and memory circuitry that stores code, the processing system configured to cause the wireless device to:
transmit a preparation request message to a first access point (AP) device, the preparation request message including a request to prepare one or more second AP devices to enable the wireless device for roaming from a third AP device to at least one of the one or more second AP devices, wherein the first AP device, the one or more second AP devices, and the third AP device are within a same mobility domain;
receive a preparation response indicating a set of the one or more second AP devices; and
transmit a roaming request message indicating at least one second AP device of the set of the one or more second AP devices.

20. A method by a wireless device, comprising:
transmitting a preparation request message to a first access point (AP) device, the preparation request message including a request to prepare one or more second AP devices to enable the wireless device for roaming from a third AP device to at least one of the one or more second AP devices, wherein the first AP device, the one or more second AP devices, and the third AP device are within a same mobility domain;
receiving a preparation response indicating a set of the one or more second AP devices that have prepared one or more resources for the roaming; and
transmitting a roaming request message indicating at least one second AP device of the set of the one or more second AP devices.
